(19) United States
(12) Patent Application Publication
(10) Pub. No.: US 2026/0101034 A1
(43) Pub. Date: Apr. 9, 2026

(54) ENCODING AND DECODING METHODS USING TRANSFORMS ADAPTED TO L-SHAPED PARTITIONS AND CORRESPONDING APPARATUSES

(71) Applicant: InterDigital CE Patent Holdings, SAS, Paris (FR)

(72) Inventors: Gagan Bihari Rath, Rennes (FR); Karam Naser, Mouaze (FR); Kevin Reuzé, Rennes (FR); Franck Galpin, Thorigne-Fouillard (FR)

(21) Appl. No.: 19/139,067

(22) PCT Filed: Nov. 27, 2023
(86) PCT No.: PCT/EP2023/083189

§ 371 Date: Jun. 13, 2025

(30) Foreign Application Priority Data
Dec. 13, 2022 (EP) 22306862.8

(51) Int. Cl. H04N 19/119; H04N 19/176; H04N 19/196; H04N 19/61; H04N 19/625

(52) U.S. Cl. CPC H04N 19/119; H04N 19/176; H04N 19/196; H04N 19/61; H04N 19/625

(57) ABSTRACT

An encoding method (decoding method respectively) is disclosed wherein an image block to be encoded (decoded respectively) is partitioned in at least two partitions, at least one of said partition has an L-shape. Various configurations are defined based on the location of the L-shape in the image block. To reduce the computation complexity, only a subset of the configurations may be allowed. A transform and an inverse transform are designed to be applied on such L-shaped partition for encoding and decoding.

### CROSS REFERENCE TO RELATED APPLICATIONS

This application claims the benefit of European Application No. 22306862.8, filed on Dec. 13, 2022, which is incorporated herein by reference in its entirety.

### TECHNICAL FIELD

At least one of the present embodiments generally relates to a method and an apparatus for encoding (decoding respectively) a picture block, and more particularly to a method and an apparatus for encoding (decoding respectively) a picture block split into partitions.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

In one embodiment, an image block to be encoded (decoded respectively) is partitioned in at least two partitions, at least one of said partition has an L-shape. Various configurations are defined based on the location of the L-shape in the image block. To reduce the computation complexity, only a subset of the configurations may be allowed. A transform and an inverse transform are designed to be applied on such L-shaped partition for encoding and decoding.

### BRIEF DESCRIPTION OF THE DRAWINGS

FIG. 1 illustrates a block diagram of a system within which aspects of the present embodiments may be implemented;

FIG. 2 illustrates a block diagram of an embodiment of a video encoder:

FIG. 3 illustrates a block diagram of an embodiment of a video decoder:

FIG. 4 illustrates the principles of directional intra prediction with reference neighbor samples;

FIG. 5 depicts the directional intra modes defined in Versatile Video Coding and Enhanced Compression Model:

FIGS. 6A and 6B illustrate horizontal and vertical partitions of a luma intra-predicted block into sub-partitions:

FIG. 7A depicts an example of four reference lines to be used by Multiple reference line (MRL) intra prediction process;

FIG. 7B depicts the set of all coding unit splitting modes supported in VVC draft 6;

FIG. 8 depicts a flowchart of an encoding method according to an embodiment;

FIG. 9 illustrates partitioning of a square block in two partitions with a top-left L-shaped partition according to an embodiment;

FIG. 10 depicts different configurations for partitioning a square block in two partitions, one being a L-shaped partition according to an embodiment;

FIG. 11 depicts different configurations for partitioning a rectangular block in two partitions, one being a L-shaped partition according to an embodiment;

FIG. 12 depicts different configurations for non-dyadic partitioning of a square block in two partitions, one being a L-shaped partition according to an embodiment;

FIG. 13 illustrates partitioning of square and rectangular blocks in three partitions with two L-shaped partitions according to an embodiment;

FIG. 14 illustrates the prediction process for a negative intra prediction direction in a case of a top-left configuration of a L-shaped partition according to an embodiment;

FIG. 15 illustrates the prediction process for a positive intra prediction direction in a case of a top-left configuration of a L-shaped partition according to an embodiment;

FIG. 16 illustrates the prediction process for a horizontal positive intra prediction direction in a case of a bottom-left configuration of a L-shaped partition according to an embodiment;

FIG. 17 illustrates the prediction process for a positive intra prediction direction in a case of a bottom-right configuration of a L-shaped partition according to an embodiment;

FIG. 18 illustrates the prediction process for a negative intra prediction direction in a case of a bottom-right configuration of a L-shaped partition according to an embodiment;

FIG. 19 illustrates the intra prediction according to the Planar mode for an L-shaped partition according to an embodiment;

FIG. 20 illustrates a forward transform process of a prediction residual block;

FIG. 21A depicts a flowchart of a method for encoding an L-shaped block of image data according to an example:

FIGS. 21B and 21C illustrate a forward transform process of a L-shaped block according to an embodiment;

FIG. 22 illustrates the process of reordering of transform coefficients for an 8×8 block;

FIGS. 23 and 24 illustrate various scanning of an L-shaped block of quantized transform coefficients;

FIG. 25 depicts a flowchart of a decoding method according to an embodiment;

FIG. 26A depicts a flowchart of a method for decoding an L-shaped block of image data according to an example;

FIGS. 26B and 26C illustrate an inverse transform process of a L-shaped block according to an embodiment; and

FIG. 27 depicts a set of all coding unit splitting modes according to an embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

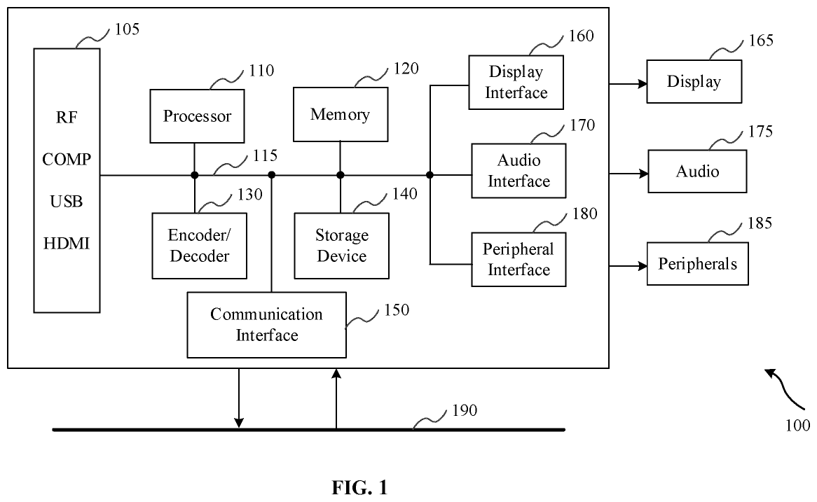

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC (Versatile Video Coding), ECM (Enhanced Compression Model) or HEVC (High Efficiency Video Coding), and can be applied, for example, to other standards and recommendations, whether pre-existing or future-developed, and extensions of any such standards and recommendations (including VVC, ECM and HEVC). Unless indicated otherwise, or technically precluded, the aspects described in this application can be used individually or in combination.

In the present application, the terms “reconstructed” and “decoded” may be used interchangeably, the terms “encoded” or “coded” may be used interchangeably, the terms “pixel” and “sample” may be used interchangeably and the terms “image.” “picture” and “frame” may be used interchangeably. Usually, but not necessarily, the term “reconstructed” is used at the encoder side while “decoded” is used at the decoder side. In the following, the terms “intra mode”, and “intra prediction mode”, “are used interchangeably. The terms “directional intra prediction mode”, “directional prediction mode”, “directional intra mode”, “directional mode”, “angular mode” and “angular intra prediction mode” are used interchangeably.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments. (iv) demodulating the down converted and band-limited signal. (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

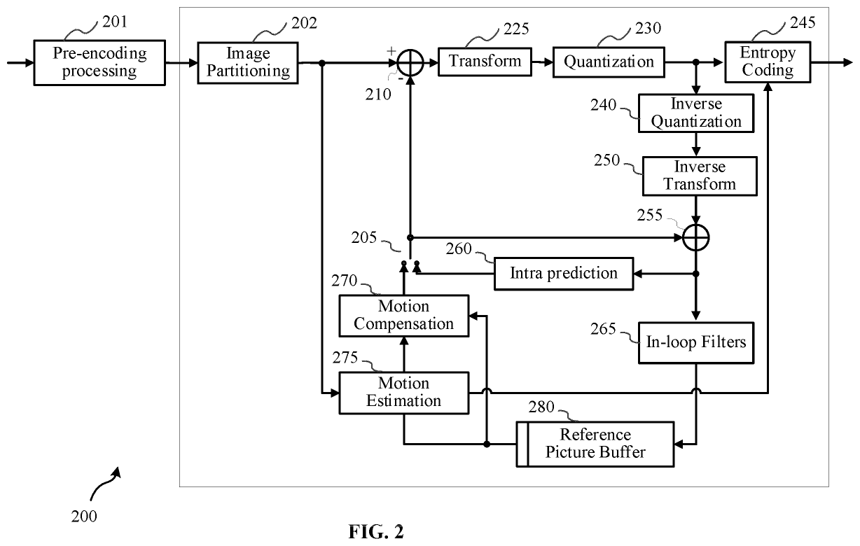

FIG. 2 illustrates an example video encoder 200, such as a VVC (Versatile Video Coding) encoder. FIG. 2 may also illustrate an encoder in which improvements are made to the VVC standard or an encoder employing technologies similar to VVC. Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260), e.g, using an intra-prediction tool such as Decoder Side Intra Mode Derivation (DIMD). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). Video coding standards such as High Efficiency Video Coding (HEVC), Versatile Video Coding (VVC) and Enhanced Compression Model (ECM 6.0) support block transforms of different types, e.g. DCT (Discrete Cosine Transform) or DST (Discrete Sine Transform), which have been designed for square or rectangular blocks. These transforms are usually applied separably to blocks of prediction residuals obtained after intra or inter prediction.

The quantized transform coefficients, as well as motion vectors and other syntax elements such as the picture partitioning information, are entropy coded (245) to output a bitstream.

The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240)) and inverse transformed (250) to decode prediction residuals. By combining (255), e.g, adding, the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

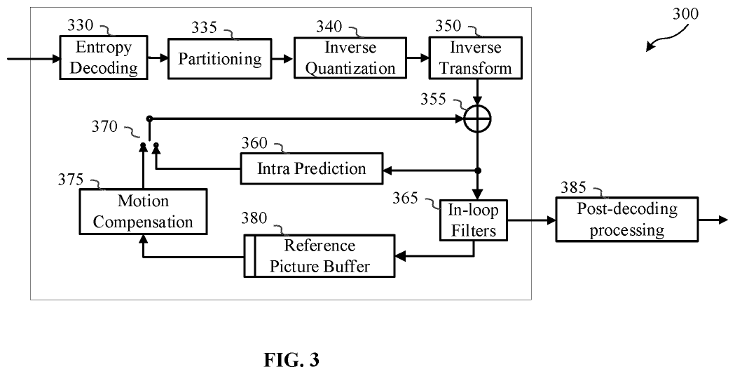

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2.

The encoder 200 also generally performs video decoding as part of encoding video data. In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355), e.g, adding, the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

In VVC and ECM, intra prediction is applied in all-Intra frames, i.e. frames comprising only intra blocks, as well as in intra blocks in Inter frames, where a coding unit (CU) is spatially predicted from the causal neighbor blocks in the same frame, i.e., the blocks on the top and top-right, the blocks on the left and left-bottom, and the top-left block. Based on the decoded pixel values in these blocks, the encoder constructs different predictions for a current block to be encoded, also called the target block, and chooses the one that leads to the best rate-distortion (RD) performance. On the decoder side, a single prediction is obtained for the target block, i.e, the block to be decoded, based on the decoded pixel values in the causal neighbor blocks. The single prediction is the one that corresponds to the intra prediction mode selected and encoded by the encoder.

Said otherwise, intra prediction (260, 360) is used to remove correlation within local regions of a picture. The basic assumption for intra prediction is that texture of a current picture region is similar to the texture in a local neighborhood, e.g, picture blocks adjacent to the current region, and can thus be predicted from there. The direct neighbor samples are commonly employed for prediction, i.e, samples from the sample line above a current block to be encoded (decoded respectively) and samples from the last column of the reconstructed blocks to the left of the current block. The samples used for the prediction of a current block belong to a causal neighborhood, i.e, they are available (thus already reconstructed) when encoding or decoding the current block.

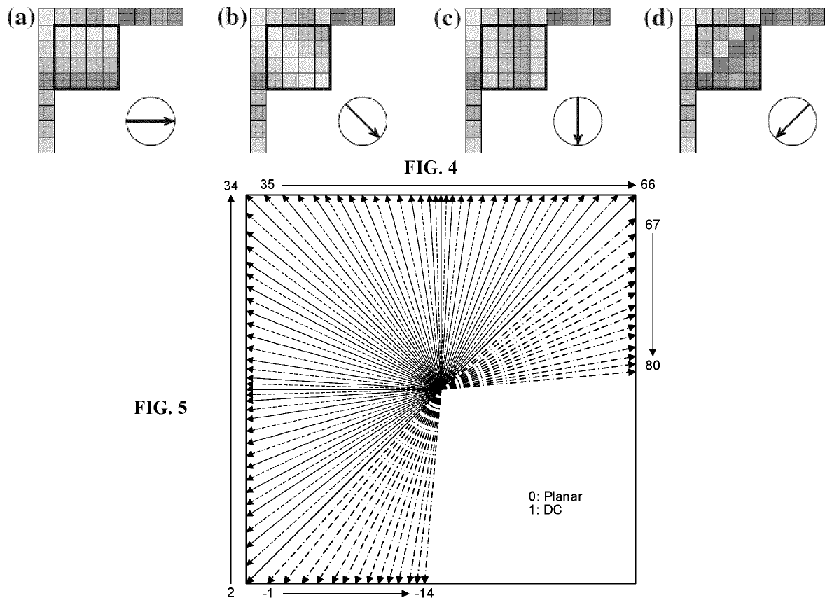

The reference neighbor samples which are used for predicting the current block depend on the intra prediction mode and possibly on the direction indicated by the intra prediction angle of the respective intra prediction mode. An illustration of directional intra prediction with its reference neighbor samples is shown in FIG. 4. For example, for horizontal prediction (case (a)), the reference neighbor samples from the left column are directly used; for vertical prediction (case (c)), the reference neighbor samples from the above row are directly used; for diagonal down right prediction (case (b)), the reference neighbor samples from the above-left side are applied and for diagonal down left prediction (case (d)), the reference neighbor samples from the above-right side are applied.

In the following sections, various tools for intra prediction in Enhanced Compression Model (ECM) are detailed.

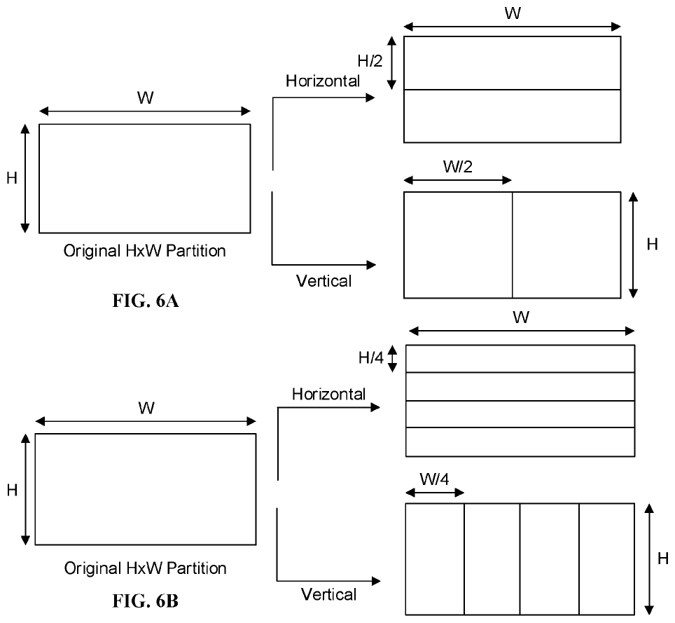

To capture the arbitrary edge directions present in natural video, the number of directional intra modes in Versatile Video Coding (VVC) and Enhanced Compression Model (ECM) is extended from 33, as used in High Efficiency Video Coding (HEVC), to 65, as depicted in FIG. 5, and the PLANAR and DC modes remain the same. These denser directional intra prediction modes apply for all block sizes and for both luma and chroma intra predictions.

In VVC and ECM, a target block (i.e, a block to be encoded or decoded) has the option of being intra predicted by a first method (intra prediction for the entire CU) or by a second method (intra prediction with sub-partitions (ISP) of the CU). In the first method, all the target pixels are predicted at the same time based on the reference samples of the entire CU in a classical manner. In the second method, the target CU is divided into two or four sub-partitions, e.g, of equal size, that are sequentially encoded (decoded respectively) with the prediction mode of the CU. That is, each sub-partition is separately encoded (decoded respectively) where its target pixels are predicted using its own reference samples. As the sub-partitions are sequentially encoded (decoded respectively), a sub-partition can benefit from the availability of the decoded samples from the neighboring sub-partition, which are immediate neighbors of the current sub-partition. This can lead to better prediction and compression efficiency than the first method in some cases.

### Intra Sub Partition (ISP)

Versatile video coding (VVC) and Enhanced Compression Model (ECM 6.0) both support intra prediction with sub-partitions (ISP) where a target block can be partitioned vertically or horizontally into two or four sub-partitions depending on the target block size as shown in Table 1. The sub-partitions are encoded and decoded sequentially with the target block considered as a single coding unit (CU). All the sub-partitions use the prediction mode of the target block (also called parent coding unit) for intra prediction, and with sequential processing, the decoded pixels in one sub-partition are used as reference samples for the intra prediction of the next sub-partition.

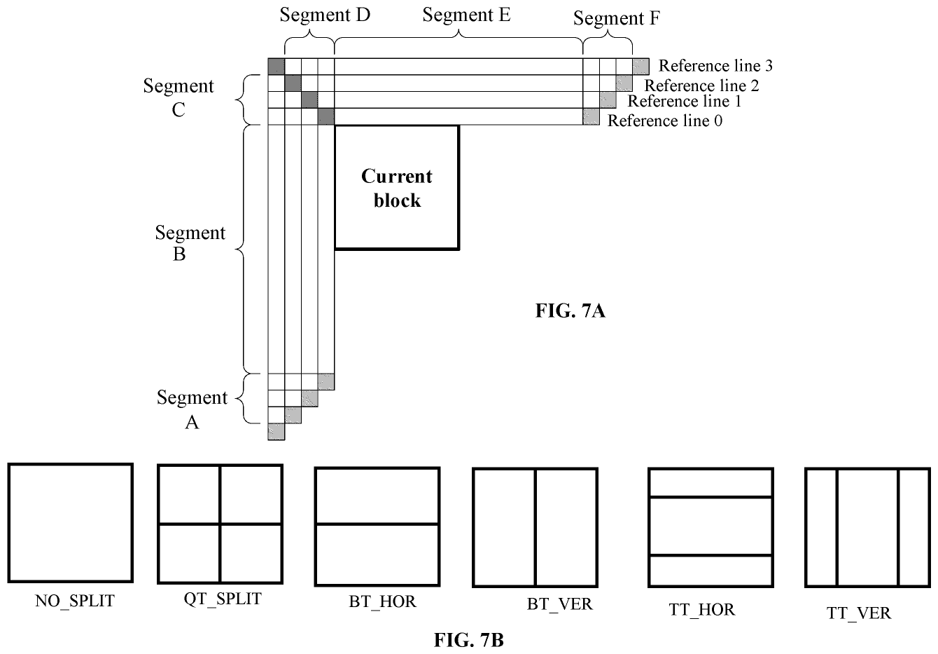

A sub-partition has at least 16 pixels. Therefore, blocks of size 4×4 are not divided into sub-partitions whereas blocks of size 4×8 and 8×4 have only two partitions. Blocks of all other sizes have only four sub-partitions. The sub-partitions can be either horizontal or vertical. A block of size 4×8 can have only two vertical partitions of size 4×4 each whereas a block of size 8×4 can have only two horizontal partitions of size 4×4 each. Similarly, a block of size 4×16, as another example, can have four vertical sub-partitions of size 4×4 each or four horizontal sub-partitions of size 1×16 each. FIG. 6A and FIG. 6B show examples of the two possibilities.

TABLE 1
Number of sub-partitions depending on the block size

| Block Size | Number of Sub-Partitions |
|---|---|
| 4 × 4 | 1 |
| 4 × 8 and 8 × 4 | 2 |
| All other cases | 4 |

For pixels in each of these sub-partitions, a prediction is constructed using the decoded prediction mode of the parent CU. These predicted values are added to the decoded residuals values, which are generated by entropy decoding the coefficients sent by the encoder and then de-quantizing and inverse transforming them. The inverse transforms are applied at the sub-partition level, like the forward transform is applied at the encoder. Except for the first sub-partition, the reconstructed pixel values of each sub-partition are available to generate the prediction of the next one. The decoded pixels on the last row (horizontal split) or the last column (vertical split) can be used as the top or the left reference array, respectively for the next sub-partition.

The sub-partitions are processed in the normal order irrespective of the intra prediction mode and the split utilized. That is, the first sub-partition to be processed is the one containing the top-left sample of the CU and then continuing downwards (horizontal split) or to the right (vertical split), sequentially. The split-type of a CU is transmitted using either bit ‘0’ (NO_SPLIT), or bits ‘10’ or ‘11’ (for HOR_SPLIT and VER_SPLIT respectively).

For each intra-coded block, a flag (e.g, isp_flag) is signaled that indicates whether ISP is to be applied or not. On condition that isp_flag is true, another syntax (e.g isp_mode) is further signaled to specify whether the split is vertical or horizontal.

### Multiple Reference Line (MRL)

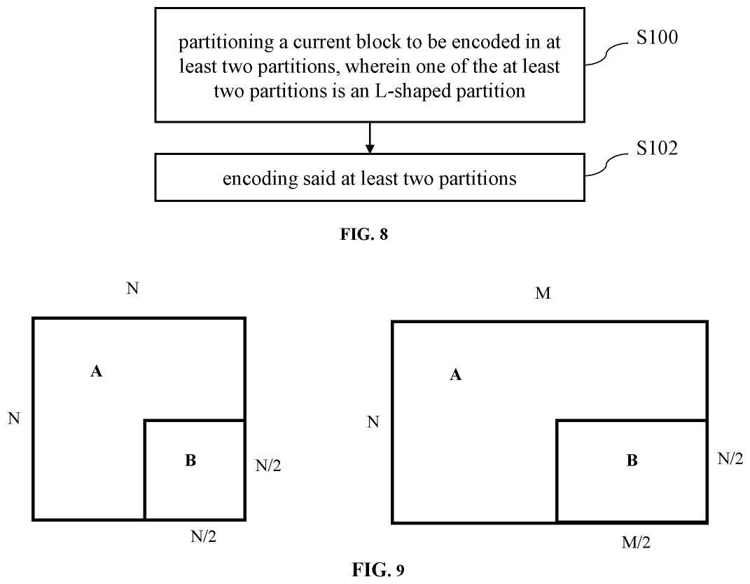

VVC and ECM also support intra prediction with multiple reference lines (MRL). A target block can choose to use among the first, the second, and the third reference lines whichever gives the best rate-distortion performance. MRL prediction mode is motivated by the observation that non-adjacent reference lines are mainly beneficial for texture patterns with sharp and strongly directed edges. If texture patterns are smooth, MRL prediction mode is expected to be less useful. In FIG. 7A, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). For example, in VVC, MRL intra prediction uses 2 additional lines (reference line 1 and reference line 2).

The index of the chosen reference line is signaled with a flag (e.g. mrl_idx) of one bit (0) to indicate the first reference line or two bits (10 or 11) to indicate the second or the third reference lines, respectively. In VVC and ECM, ISP is considered only with the first reference line. Therefore, if a block has an MRL index other than 0, then the isp_flag is inferred to be 0 and therefore it is not sent to the decoder. In this case, the intra prediction is performed for the whole CU without any splits. Thus, the isp_flag is parsed depending on whether the mrl_idx flag is 0.

In HEVC, VVC, ECM, the compression is done at the block level instead of at the entire image level, or instead of at the level of an entire frame of a sequence. Therefore, a frame is divided into a set of non-overlapping blocks called coding tree units (CTUs) and then each CTU is compressed by scanning them sequentially. The CTUs undergo recursive partitioning into blocks called coding units (CUs) which undergo prediction before the transforms are applied on the prediction residuals. In intra frames, all CUs undergo intra prediction based on previously decoded neighbor pixels in the same frame, whereas in interframes a CU can have either intra prediction, or inter prediction based on the pixels in the neighboring areas in previously decoded frames. These CUs can be only of dyadic square shape (in HEVC), or of dyadic square or rectangular shape (in VVC, ECM) because of quadtree (QT), binary tree (BT) and triple tree (TT) partitioning structures. More precisely, in VVC, a coding tree unit (CTU) is first partitioned by a quadtree structure, then each quadtree leaf nodes can be further partitioned in a binary or ternary fashion. As shown in FIG. 7B, there are four splitting types in VVC in addition to the NO_SPLIT and quadtree splitting (QT_SPLIT): vertical binary splitting (BT_VER), horizontal binary splitting (BT_HOR), vertical ternary splitting (TT_VER), and horizontal ternary splitting (TT_HOR). The TT_HOR or TT_VER splitting (horizontal or vertical triple tree splitting mode) consists in dividing a parent block into 3 sub-blocks (e.g. CUs), with respective sizes equal to 1/4, ½ and ¼ of the parent block size in the direction of the considered spatial division. In the same way, the sub-partitions as defined by ISP tool in VVC and ECM have been designed for dyadic coding units (CUs) and are always of rectangular or square shape depending on the target CU size.

Block transforms such as discrete cosine transform (DCT) and discrete sine transform (DST) have been included in standards such as JPEG, HEVC, VVC, ECM, etc. Whether they are applied directly on image data, such as in JPEG, or on prediction residuals, such as in HEVC, VVC, ECM, etc., they provide high de-correlation and energy compaction properties which ensure effective compression of the visual data. Besides, as they are orthogonal transforms, the inverse transforms are easily obtained by transposing the forward transform matrices thus eliminating the need for separate inverse transform matrices. In view of the hardware implementation, integer versions of these transforms, which are obtained by scaling and rounding the original floating-point transforms, are specified in the above mentioned standards. In these standards, the transforms are designed for square or rectangular blocks of dyadic sizes and the transform operation is performed separably by multiplying with one right transform matrix and another left transform matrix. If other partitioning shapes, e.g, an L-shaped partitioning, are defined which do not permit such straightforward separable operations, the transform matrices need to be modified or redefined.

The CTU recursive partitioning into CUs or the ISP partitioning of a CU into sub-partitions can sometimes lead to sub-optimal partitioning, e.g. because it does not correspond to underlying objects in those CUs. Therefore, extending the CTU recursive partitioning and ISP partitioning to other type of partitioning, e.g, an L-shaped partitioning, may improve compression efficiency. In this context it is necessary to design transforms and inverse transforms for such new types of partitioning that will be used to encode or decode the residuals resulting from intra/inter prediction.

In the following sections, the CTU recursive partitioning and ISP partitioning are modified to improve compression efficiency. More precisely, a new L-shaped partitioning is introduced. In an example, a parent CU (or parent block) is divided in at least two partitions (namely two child CUs or two ISP sub-partitions) where one of the two partitions has an L-shape and the other has a square or rectangular shape depending on if the parent CU has square or rectangular shape respectively. This can be in the context of the CTU recursive partitioning into CUs, or in the context of intra prediction with sub-partitions (ISP). In an example, the L-shaped partition contains three fourths of the samples, and the square or rectangular partition contains the remaining one fourth of the samples of the parent CU. In another example, a parent CU is divided in at least two partitions where more than one partition is an L-shaped partition. In an example, the partitions are limited to a dyadic case, that is, the lengths of the sides of the L-shaped partition and the other rectangular or square partition are powers of 2. In other examples, it is possible to have partitions with non-dyadic lengths.

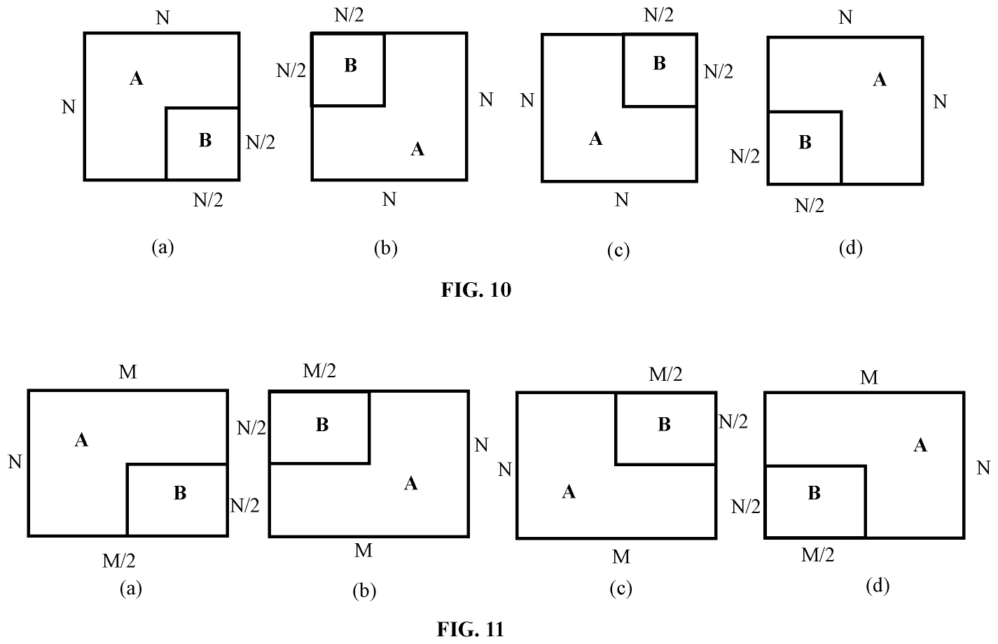

FIG. 8 depicts a flowchart of an encoding method according to an embodiment.

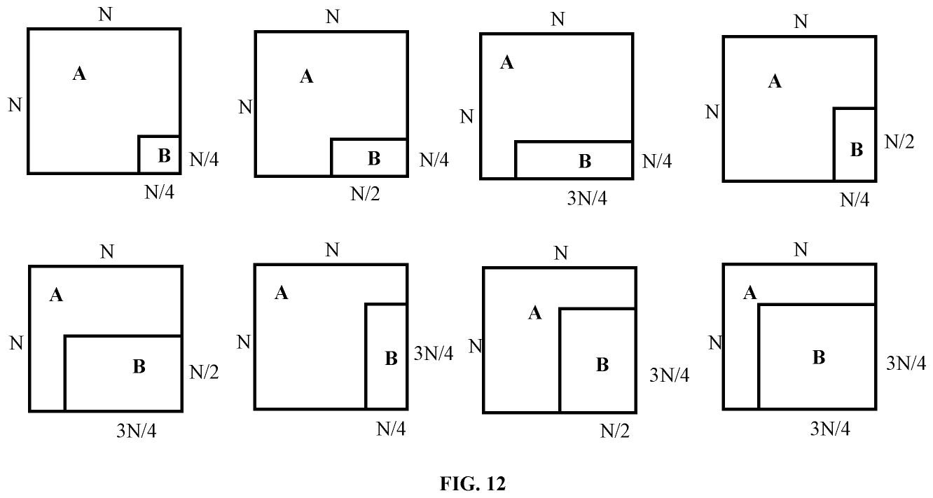

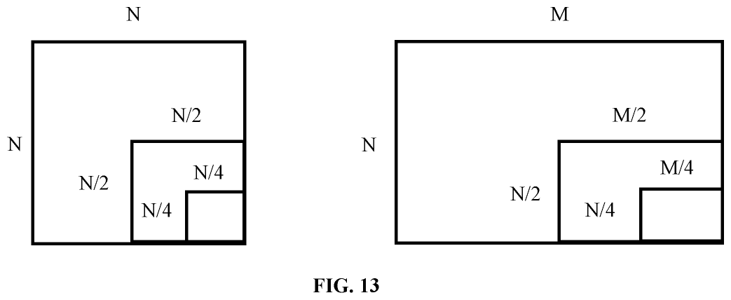

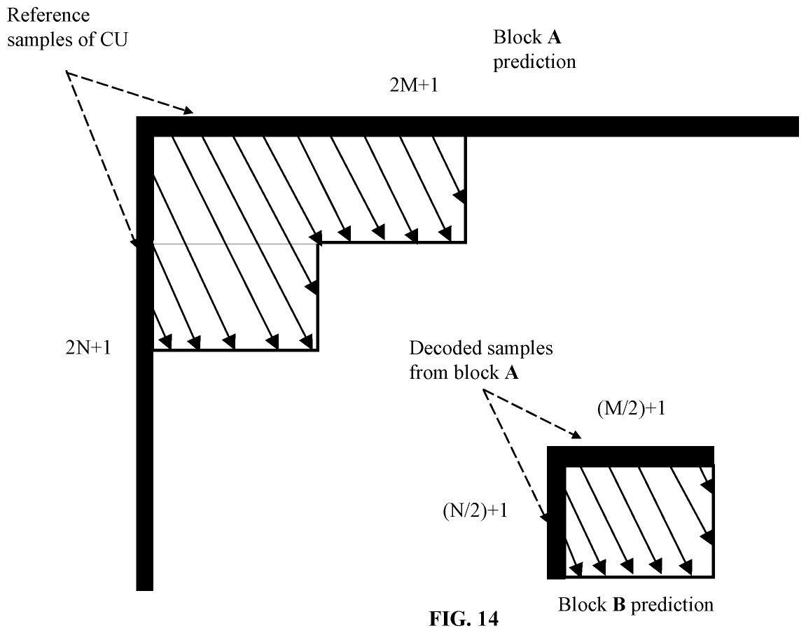

In a step S100, a current block (also referred to as CU or parent CU) to be encoded is partitioned (also referred to as split or divided) in at least two partitions (also referred to child CUs or more simply CUs, ISP sub-partitions or more simply sub-partitions, blocks or sub-blocks), one of said at least two partitions being an L-shaped partition. Said otherwise, a partition can itself be a CU in the context of CTU recursive partitioning, or a sub-partition in the context of ISP. The current block may be a square of size N×N or a rectangular block of size N×M, N being different from M, N and M being positive integers. In an example, the current block is split into at least two partitions, one of said at least two partitions being an L-shaped partition and the other one being a rectangular or a square partition depending on the shape of the current block. In an example depicted on the left of FIG. 9, the partition B has a square shape as the current block to be encoded is square. In another example depicted on the right of FIG. 9, the partition B has a rectangular shape as the current block to be encoded is rectangular. In a specific example, the latter partition is assumed to have at least 8 pixels so that CUs of sizes 4×8 and 8×4 can have this split. FIG. 10 and FIG. 11 illustrate different configurations of the L-shape partition whose name is defined with respect to the corner of the current block that comprises the L-shaped partition: (a) top-left. (b) bottom-right. (c) bottom-left, and (d) top-right. In the above examples, the L-shaped partition is obtained by using a half split in horizontal direction and a half split in vertical direction. Thus, the L-shaped partition has three fourths of the pixels, and the other rectangular or square partition contains one fourth of the pixels of the current block. In the case where the current block width and height are powers of 2, the above splits are dyadic, i.e, the lengths of all sides of the L-shaped partition A and those of the rectangular or square partition B are powers of 2. Indeed, an L-shaped partition has six sides. If the largest two sides have lengths M and N, two of the remaining sides have lengths equal to M/2, and the remaining two sides have lengths equal to N/2. In the case where the parent CUs have dyadic lengths. M and N are powers of 2, and so are (M/2) and (N/2). In the following, an L-shaped partition is said to be symmetric if its largest two sides have equal lengths, that is if M=N; and, otherwise, the L-shaped partition is said to be asymmetric.

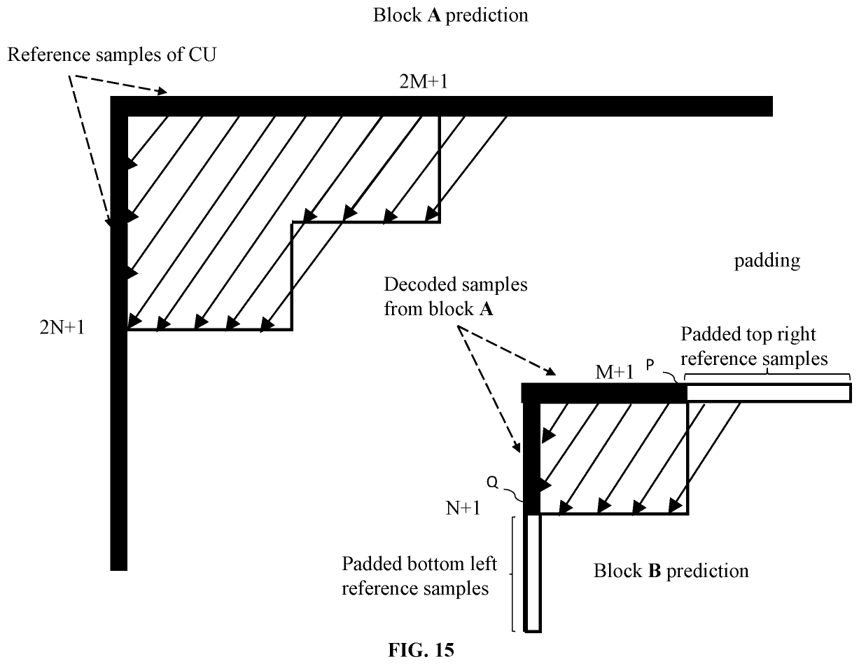

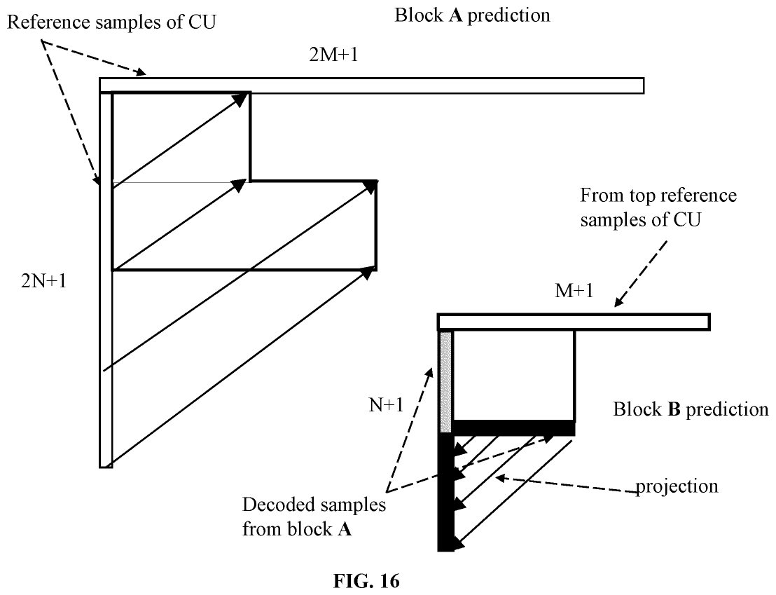

FIG. 12 depicts non-dyadic splits for a square current block where at least one side of either A or B partition is not a power of 2. Similar non-dyadic splits are possible with a rectangular current block. In yet another example, the current block is partitioned into more than one L-shape partition, e.g. by recursively splitting the square or rectangular partition B as depicted on FIG. 13. More precisely, in FIG. 13, the current block is partitioned in three partitions, wherein two of the three partitions are L-shaped partitions.

In a step S102, the at least two partitions are encoded. In an example, the at least two partitions A and B are two child blocks resulting from CTU recursive partitioning of a parent block. A being an L-shaped CU that can be either intra or inter encoded and B being a square or rectangular CU or being a square or rectangular block that is recursively partitioned into CUs. In another example, the at least two partitions A and B are two ISP sub-partitions of an intra parent CU. In this case the L-shaped CU is intra encoded. The encoding sequence order of sub-partitions in ISP in VVC or ECM is fixed. With horizontal split, the sub-partitions are processed from top to bottom, and with vertical split, the sub-partitions are processed from left to right. A similar approach can be followed here by first encoding the L-shaped sub-partition A (also called block A in the following) and then encoding the sub-partition B (also called block B in the following), irrespective of the configuration type. In another example, the encoding sequence order of sub-partitions can depend on the type of configuration, said configuration being depicted on FIGS. 10 and 11. For the top-left configuration, the L-shaped block A is processed first and then block B as only block A has both its top and left reference lines available. Once block A is processed, the decoded pixels on top and left of block B can be then used as reference pixels for the block B. For the bottom-right configuration, either encoding sequence order can be followed, but processing block B first will make decoded pixels available on all top and left sides of block A which is advantageous. For the bottom-left and top-right configurations it may be preferable to first process block A followed by block B, as block B does not have the reference samples on one side. Once block A is processed, then block B can use the decoded pixels on its top or left along with the left or top reference samples of the CU depending on the configuration.

On the encoder side, for the current block, one configuration is selected among a set of configurations based on RD optimization. In order to limit complexity, the number of configurations in the set may be limited, e.g, to 1 or 2 configurations. The configuration(s) chosen to be in the set can be fixed. As an example, the set may comprise only the top-left configuration in the case where only one configuration is allowed, or the top-left and the bottom-right configurations in case where two configurations are allowed. In another example which applies to ISP, the chosen configurations can depend on the intra prediction, e.g, on the intra prediction direction of the current block. By convention, an intra prediction is considered to be positive in the case where the direction is from top right towards bottom-left or from bottom-left towards top right and an intra prediction is considered to be negative in the case where the direction is from top left towards bottom-right. With this convention, if the intra prediction direction of the current block is negative, either only the top-left or the bottom-right configuration can be chosen. Else, if the intra prediction direction is positive, either only the bottom-left or the top-right configuration (depending on if the prediction direction is horizontal or vertical respectively) can be chosen.

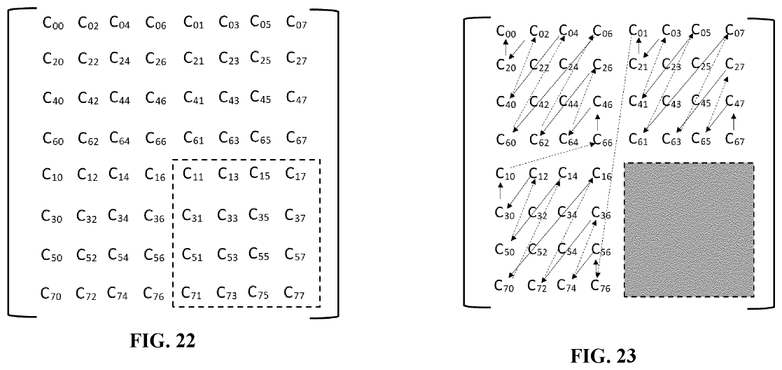

To encode the L-shaped CU A, prediction residuals are thus obtained, for example, by subtracting the predicted L-shaped CU resulting from either intra or inter prediction from the original L-shaped CU A. In case of intra prediction, an intra prediction mode is associated with the L-shape CU and may be a directional intra prediction mode (also referred to as angular prediction mode) or a non-directional prediction mode (also referred to as non-angular prediction mode), e.g. DC or Planar mode. In case of inter prediction, the L-shaped CU A is predicted from samples in decoded past or future frames. More precisely, the L-shaped CU A is predicted using motion estimation and compensation of reference frames stored in a reference picture buffer. The prediction residuals are usually but not necessarily transformed and quantized. An example of a specific transformation process for an L-shaped block is disclosed with reference to FIGS. 21A and 21B. The transform coefficients in the three quadrants of the L-shaped CU are quantized, e.g, with quantization step sizes associated with (e.g., mapped to or corresponding to) their frequency indices. Subsequently, the quantized transform coefficients undergo a suitable scanning method before being entropy encoded in a bitstream (also referred to as encoded data). The encoder reconstructs the encoded L-shaped CU to provide a reference for further predictions, e.g, for an intra predicted CU B. To this aim, the quantized transform coefficients are de-quantized and inverse transformed to obtain prediction residuals. By combining (e.g, adding) the prediction residuals and the predicted L-shaped CU, an L-shaped CU is reconstructed. The square or rectangular partition B may be directly encoded in a classical manner (i.e. by prediction, transform, quantization, possibly binarization, and entropy coding) in the case where it is a CU, i.e, in the case where it is not further recursively partitioned into a plurality of CUs. In the case where the square or rectangular partition B is recursively split into a plurality of CUs, each of these CUs are encoded either as disclosed above in the case of an L-shape CU or in a classical manner in a case of a square or rectangular CU. In other examples, partition B may be encoded before CU A in which case reconstructed samples from partition B may be used as reference for encoding L-shaped CU A in the specific case where L-shaped CU A is intra coded.

To encode the L-shaped ISP sub-partition A (also called block A in the following), prediction residuals are thus obtained, for example, by subtracting the predicted L-shaped block A (resulting from intra prediction) from the original L-shaped block A. The same intra prediction mode, namely the intra prediction mode selected for the current block (i.e, parent CU), is used for both sub-partitions A and B. The intra prediction mode may be a directional intra prediction mode (also referred to as angular prediction mode) or a non-directional prediction mode (also referred to as non-angular prediction mode), e.g. DC or Planar mode. The prediction residuals are usually but not necessarily transformed and quantized. An example of a specific transformation process for an L-shaped block is disclosed with reference to FIGS. 21A and 21B. The transform coefficients in the three quadrants of the L-shaped CU are quantized, e.g, with quantization step sizes associated with (e.g., mapped to or corresponding to) their frequency indices. Subsequently, the quantized coefficients undergo a suitable scanning method before being entropy encoded in a bitstream (also referred to as encoded data). The encoder reconstructs the encoded L-shaped block to provide a reference for further predictions, e.g, for sub-partition B (also called block A in the following). To this aim, the quantized transform coefficients are de-quantized and inverse transformed to obtain prediction residuals. By combining (e.g, adding) the prediction residuals and the predicted L-shaped block, an L-shaped block is reconstructed. The square or rectangular sub-partition B is encoded in a classical manner. In other examples, sub-partition B may be encoded before sub-partition A in which case reconstructed samples from sub-partition B may be used as reference for encoding L-shaped sub-partition A.

Additional information (e.g, syntax elements) may be encoded. The information may comprise in addition to the quantized transform coefficients, prediction modes (e.g, intra prediction mode(s)), motion vectors in case of inter coding and possibly partitioning configuration information indicating how the current block is partitioned in at least two partitions. In addition, the information may comprise, e.g, an indication that L-shaped blocks are allowed. In an example, a syntax element may be encoded in a slice header to indicate that all CUs in a slice may use the L-shape split. In an example, a syntax element may be encoded in the PPS header to indicate that all CUs in a frame can use the L-shape split. In an example, a syntax element may be encoded in the SPS header to indicate that all CUs in all frames may use the L-shape split.

### Directional Intra Prediction for L-Shaped CU or L-Shaped Sub-Partition

In the following, we consider the top-left configuration with the L-shape partition A being encoded first. As explained previously, the at least two partitions A and B may be two child CUs resulting from CTU recursive partitioning of the parent CU or may be two ISP sub-partitions of an intra parent CU.

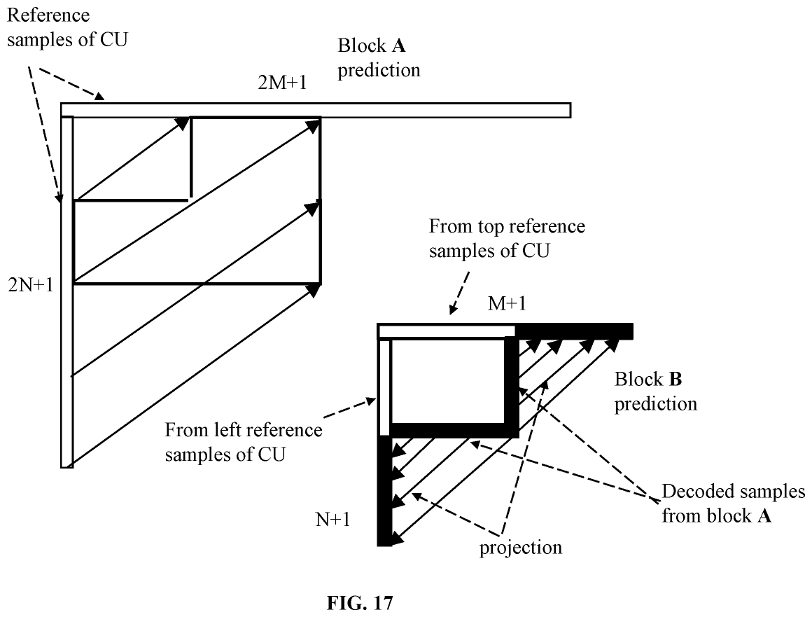

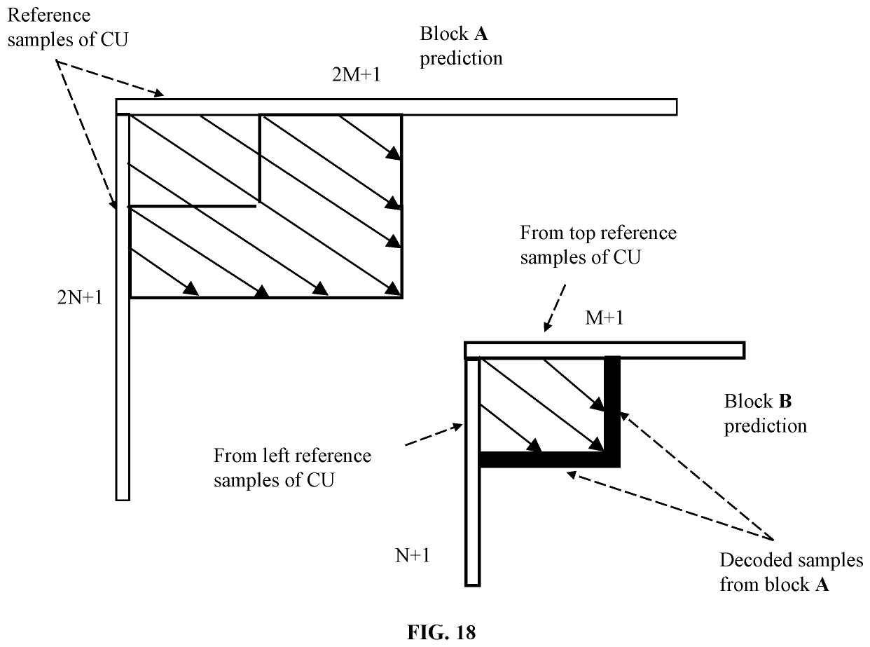

In the case of ISP, FIG. 14 illustrates the prediction process for a negative prediction direction and FIG. 15 illustrates the prediction process for a positive prediction direction. In both cases, using the prediction mode of the parent CU, the encoder performs the prediction of the samples of the L-shaped partition A in a usual manner, i.e, using the reference samples of the parent CU located on top of it (2M+1 samples) and on its left (2N+1 samples). The L-shaped partition A is then encoded (e.g., by obtaining prediction residuals which are transformed and quantized) and reconstructed.

Once the partition A is encoded and reconstructed, the encoder performs the prediction of the samples of partition B using reconstructed samples in partition A. The reconstructed samples located on the top and on the left of the partition B are used as reference samples. In the case of a positive prediction direction FIG. 15, bottom left and top right reference samples are padded. More precisely, the top right reference samples are padded by copying the right most black pixel P and the bottom left reference samples are padded by copying the bottom most black pixel Q. As depicted on FIG. 15, partition B is predicted from N+1 left reference samples and M+1 top reference samples.

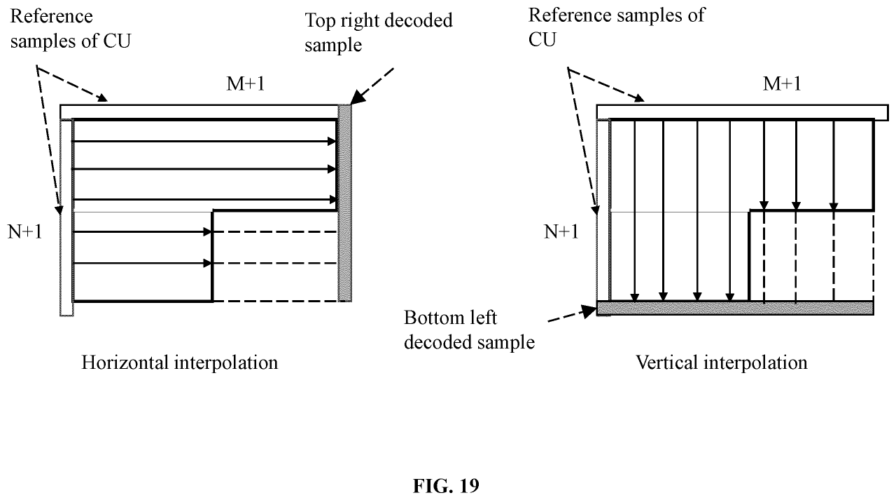

In the following, we consider the bottom-left configuration with the L-shape partition A being encoding first. FIG. 16 illustrates the prediction process in the case where the prediction direction is horizontal positive. In case of negative direction, one can simply use the decoded pixels from L-shape partition A on the left. In this case, using the prediction mode of the parent CU in case of ISP, the encoder performs the prediction of the samples of L-shaped partition A in a usual manner, i.e, using the reference samples of the parent CU located on top of it (2M+1 samples) and on its left (2N+1 samples). As in the previous configuration. L-shaped partition A is encoded and reconstructed. Once the partition A is encoded and reconstructed, the encoder thus performs the prediction of the samples of partition B using reconstructed samples in partition A. The top reference samples for partition B are obtained from the top reference samples of the parent CU. In one example, the decoded samples of the L-shaped partition A used to predict the partition B are the samples that are located on the left and just below the partition B. In a particular implementation, so called top and left reference arrays are used to predict any intra block. Such arrays are namely defined in VVC and ECM. Therefore, in this implementation, the top reference array for partition B comprises the top reference samples of the parent CU (namely M+1 samples as depicted on FIG. 16). The left reference array comprises the decoded samples from partition A at the border (in grey on FIG. 16), i.e. located to the left of a left edge of said partition B. If the prediction direction is positive, the remaining reference samples of the left reference array (in black on FIG. 16) are obtained by projecting the decoded samples below the partition B onto the left reference array, as shown in FIG. 16. More precisely, for each pixel position on the lower part of the left array, the decoded sample position on the bottom (i.e, decoded samples below the partition B) in the direction of the prediction is determined. That sample may not match with a decoded sample at integer position, but may be between two decoded samples. In this case, the sample is interpolated (either linear interpolation with 2 nearest neighbors, or cubic cubic with 4 nearest neighbors (higher complexity but more accurate). This is similar to obtaining the left part of the top reference array in negative prediction direction in a regular CU prediction. The left reference array thus comprises N+1 sample values as depicted on FIG. 16. In the case where the prediction direction is negative, that is, from top-left towards bottom-right, the availability of decoded samples below the partition can be used for smoothing in a similar manner to PDPC (Position Dependent Prediction Combination) defined in VVC. PDPC modifies the original prediction with a weighted average of the original prediction and the reference samples of a target block to have a gradual intensity change at top and left sides of the block. As in the previous configuration, once predicted, the partition B is encoded and reconstructed.

The case of the top-right configuration with the L-shape partition A being encoded first is analogous to the bottom-left configuration with the L-shape partition A being encoded first. More precisely, the top-right configuration in the case of a vertical positive direction is analogous to the bottom-left configuration in case of a horizontal positive direction.

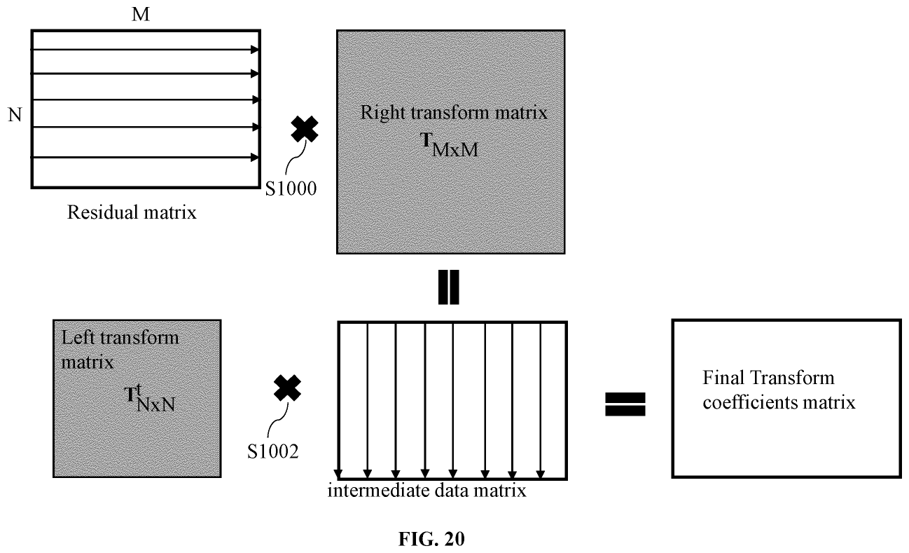

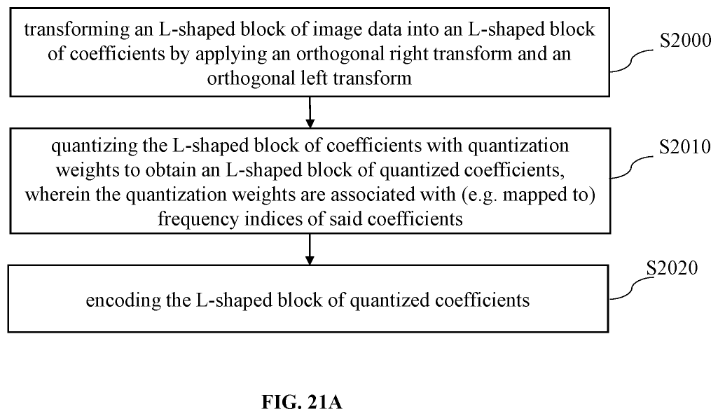

For the bottom-right configuration, considering that partition A is processed first followed by partition B, the prediction process for partition A and partition B are illustrated by FIGS. 17 and 18. FIG. 17 illustrates the prediction process for a positive prediction direction and FIG. 18 illustrates the prediction process for a negative prediction direction. In this case, using the prediction mode of the parent CU in case of ISP, the encoder performs the prediction of the samples of L-shaped partition A in a usual manner, i.e, using the reference samples of the parent CU on top of it (2M+1 samples) and on its left (2N+1 samples). As in the previous configuration. L-shaped partition A is encoded and reconstructed. Once the partition A is encoded and reconstructed, the encoder thus performs the prediction of the samples of partition B using reconstructed samples in partition A. For partition B, decoded samples on all four sides of the partition are available. If the prediction direction is positive, then the decoded samples below and on the right of the partition B are projected onto the left and top reference arrays, more precisely on bottom left and top right parts of the arrays respectively (in black on FIG. 17). The remaining reference samples (in white on FIG. 17) on the left and on the top are taken from the reference samples of the parent CU. The left reference array thus comprises N+1 sample values and the top reference array comprises M+1 samples values as depicted on FIG. 17. If the prediction direction is negative as illustrated by FIG. 18, the reference samples are obtained from the reference samples of the parent CU in a usual manner. In this case, a process similar to PDPC may be applied on the right and bottom borders to smoothen the discontinuity. More precisely, decoded samples below and on the right of the partition B can be used for smoothing in a similar manner to PDPC, or by any other smoothing algorithms. As in the previous configuration, once predicted, the partition B is encoded following the usual process of transform of the prediction residuals, quantization, and binary encoding, and reconstructed with dequantization, inverse transform and then adding the decoded residuals to predicted values. The examples disclosed with respect to FIGS. 14-17 in case of ISP may be extended to an L-shaped CU A with a square or rectangular CU B in the case where the CU B is intra encoded. The difference with ISP is that the L-shaped CU may be either intra or inter encoded. In the latter case, the L-shaped CU is predicted from samples of past or future frames. Besides, if CU B is inter encoded, or further partitioned, these examples will not apply.

### Non-Angular Intra Prediction Modes for L-Shaped CU or L-Shaped Sub-Partition

VVC and ECM include two non-angular intra prediction modes: PLANAR mode indexed as mode 0 and DC mode indexed as mode 1. These two prediction modes model slow changing intensity regions in a frame. It is necessary to specify these two modes with an L-shaped partition so that they can be used for example with L-shaped partition in ISP or with an L-shaped CU. In the following we use the top-left configuration to illustrate the two modes. A similar approach can be followed in other configurations. The L-shaped partition A (i.e. L-shaped CU or L-shaped sub-partition) is assumed to be encoded and reconstructed first.

The intra prediction of L-shaped partition A is performed using the reference samples of the parent CU in a usual manner. If the prediction mode of the CU is DC, then the DC value is computed as usual using the top and left reference samples and the L-shaped partition is filled with that value. More precisely, the DC value is the mean sample value of the reference samples located to the left and above the L-shaped partition A in the case where the parent CU is square.

Otherwise (i.e, the parent CU is not square), the DC value is the mean value of the samples on the larger side.

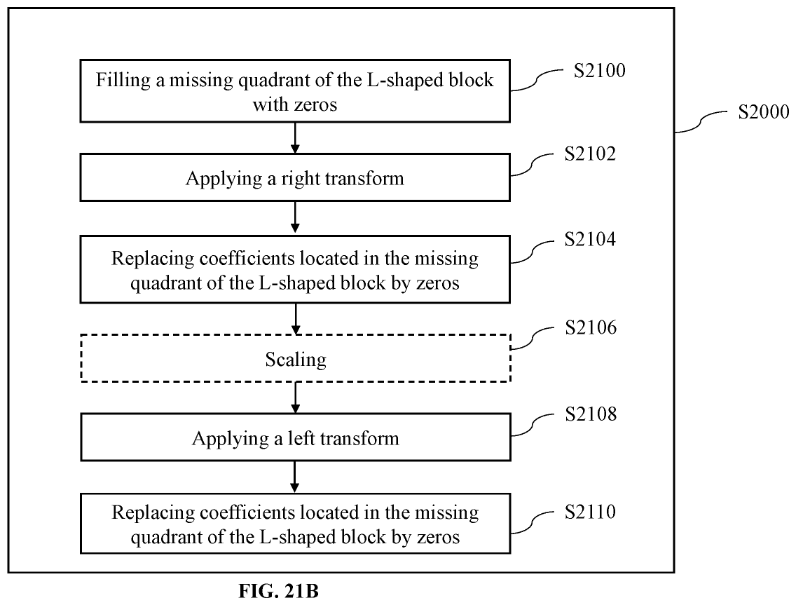

If the prediction mode is PLANAR, the prediction is done in the usual manner as the average of a horizontal interpolation and a vertical interpolation where, for the horizontal interpolation, the top-right decoded sample is repeated at the right edge, and for the vertical interpolation, the bottom-left decoded sample is repeated at the bottom edge. More precisely, in the Planar mode, the predicted sample values are obtained as a weighted average of 4 reference sample values. Here, the reference samples in the same row or column as the current sample and the reference samples on the bottom-left and on the top-right position with respect to the L-shaped partition are used. The interpolation is performed over the L-shaped partition only. This is shown in FIG. 19 for the top-left configuration. The horizontal and vertical interpolations are performed up to the edge of the L-shaped partition. For both the DC and the Planar modes, the subsequent smoothing step using the PDPC can be done in a usual manner.

### Transform for L-Shaped CU or L-Shaped Sub-Partition

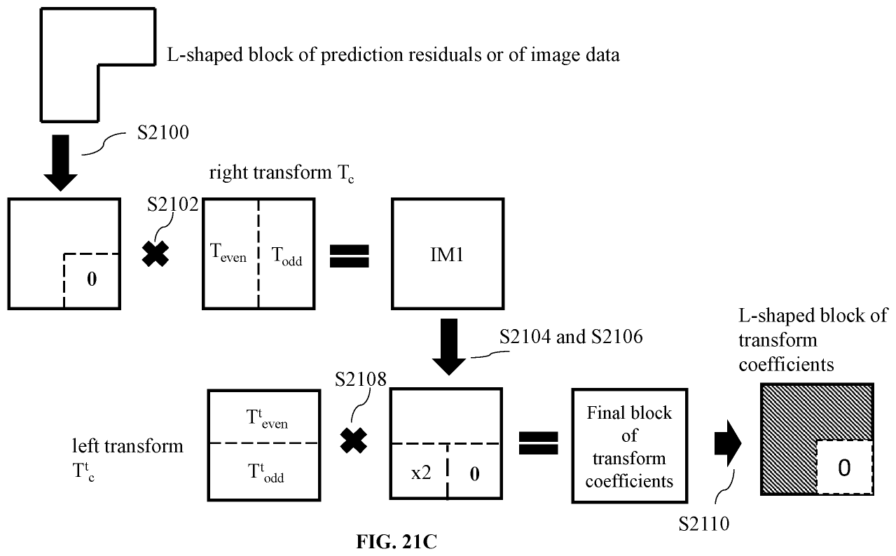

FIG. 20 illustrates the forward transform of prediction residuals for a rectangular or square block, e.g. for partition B. When the prediction residuals of a sub-partition in ISP or of a CU are transform-coded, two orthogonal transforms are usually applied for that purpose.

A right orthogonal transform T_{MxM} is applied (S1000) on each row of the residual matrix of size N×M to obtain an intermediate data matrix. Then, a left orthogonal transform T′N×N is applied (S1002) on each column of the intermediate matrix to obtain the final transform coefficients matrix. Since the transforms specified in the standards are integer versions of original transforms, there is a scaling step that is operated after each transform operation to bring down the coefficients within the working dynamic range. The transform coefficients are quantized and then encoded in binary form, i.e. binarized, before being lossless entropy encoded with CABAC. For the decoding of the prediction residuals, the inverse process is followed. After the dequantization, the transform coefficients are inverse transformed with a left and a right inverse transform matrix, which are the transposes of the corresponding forward transform matrices. As in forward transform, a scaling step may be applied after each inverse transform operation.

One solution to transform the L-shaped partition A may be to insert zeros in the missing quadrant (i.e, the part corresponding to the partition B) in order to create a square or rectangular block and then to apply right and left transforms in the usual manner, e.g, as illustrated on FIG. 20. However, this solution results in large high-frequency coefficients whose quantization can cause visible artefacts after inverse transform operation. In addition, such a transform operation would generate M*N coefficients whereas the L-shaped partition A has (3*M*N/4) samples, giving thus a redundant over-complete representation. The proposed transform and inverse transform methods make it possible to limit or even avoid the above problems.

The DCT of an N-dimensional real vector x=[x₀ x₁ x₂ . . . x_{N-1}] is defined as X=[X₀ X₁ X₂ . . . X_{N-1}] where

$${X}_{k} = {\sum }_{n = 0}^{N - 1} {x}_{n} cos [ \frac{π}{N} ( n + \frac{1}{2} ) k ] for k = 0 , 1 , 2 , … N - 1 .$$

The coefficient vector X is also a real vector. Thus, the DCT transform matrix is defined as T={t_{n,k}}_{n=0 . . . N-1; k=0 . . . N-1} where the (n, k)th element of the matrix is given by

$${t}_{n , k} = cos [ \frac{π}{N} ( n + \frac{1}{2} ) k ] ,$$

The columns of matrix T are the DCT basis vectors. The above transform operation can be equivalently written as X=xT, where T is a matrix of dimension N×N and x and X are row vectors of size N as defined above.

Considering only dyadic lengths, N is a power of 2. Now, considering only the even columns of matrix T, i.e, the columns having index

$$k = 2 * j , for j = 0 , 1 , … ( \frac{N}{2} - 1 ) ,$$

the elements of those

$$( \frac{N}{2} )$$

columns can be expressed as follows:

$${t}_{n , 2 j} = cos [ \frac{π}{N} ( n + \frac{1}{2} ) * ( 2 j ) ] = cos [ \frac{π}{( \frac{N}{2} )} ( n + \frac{1}{2} ) j ] for n = 0 , 1 , … N - 1 ; j = 0 , 1 , … \frac{N}{2} - 1.$$

Taking only the first

$$( \frac{N}{2} )$$

elements from each column, we get a matrix of dimension

$$( \frac{N}{2} ) x ( \frac{N}{2} )$$

whose elements are given by

$${t}_{n , k} = cos [ \frac{π}{( \frac{N}{2} )} ( n + \frac{1}{2} ) k ] , for n = 0 , 1 , … ( \frac{N}{2} ) - 1 and for k = 0 , 1 , … ( \frac{N}{2} ) - 1.$$

This is nothing but the DCT matrix for dimension

$$( \frac{N}{2} ) .$$

Thus, the DCT basis vectors of dimension

$$( \frac{N}{2} )$$

can be obtained from the even DCT basis vectors of dimension N by taking only the first (N/2) elements of each basis vector.

The DCT vectors defined above are not normalized, and hence they are orthogonal but not orthonormal. In practice, they are normalized by multiplying with

$$\frac{1}{\sqrt{N}}$$

so that the resulting transform matrix is orthonormal. This allows to use the same matrix for inverse transform by taking its transpose. In this case, the DCT basis vectors of dimension

$$( \frac{N}{2} )$$

can be obtained from the even DCT basis vectors of dimension N by taking only the first (N/2) elements and scaling them by √2 .

The above observation helps us get the DCT coefficients of an

$$( \frac{N}{2} )$$

dimensional vector by using the even basis vectors of N×N transform matrix by (1) padding the input vector, (2) multiplying with even columns, and (3) scaling by \sqrt{2}. Let y=[y₀ y₁ y₂ . . . y_{N/2-1}] denote the input vector of dimension

$$( \frac{N}{2} ) .$$

Let Tₑᵥₑₙ and T_{odd} denote the matrices comprising the even and odd columns of transform matrix T respectively, which is of dimension N×N. Thus, Tₑᵥₑₙ and T_{odd} both have dimension

$$N ⨯ ( \frac{N}{2} ) .$$

Note that Tₑᵥₑₙ and T_{odd} contain the respective columns in sequential order. Thus, the DCT coefficient vector

$$Y ≡ [ {Y}_{0} {Y}_{1} … {Y}_{( \frac{N}{2} ) - 1} ]$$

can be obtained as follows Y=(yₚ)(Tₑᵥₑₙ)(\sqrt{2}), where

$${y}_{p} ≡ [ y {0}_{1 x ( \frac{N}{2} )} ] = [ {y}_{0} {y}_{1} {y}_{2} … {y}_{\frac{N}{2} - 1} 00 … 0 ] .$$

here

$${0}_{1 x ( \frac{N}{2} )}$$

denotes a row vector of

$$( \frac{N}{2} )$$

zeros. In the above operation, we have used the parentheses to identify the three steps mentioned below:
(1) Padding with

$$( \frac{N}{2} )$$

zeros to get input vector yₚ;
(2) Multiplying with transform matrix Tₑᵥₑₙ; and
(3) Scaling with √2.

A new transform matrix by concatenating the even and odd transform matrices as follows:

$${T}_{c} ≡ [ {T}_{e v e n} {T}_{o d d} ]$$

The new transform matrix has dimension N×N. The transform coefficient vector Y can still be obtained by multiplying yₚ with T, and discarding the last

$$( \frac{N}{2} )$$

coefficients which results from the multiplication of yₚ with T_{odd}, and scaling the remaining coefficients by \sqrt{2}. This leads us to get the DCT transform coefficients of a symmetric L-shaped block as disclosed below. Any transform (e.g. DCT Type II transform as specified in HEVC and VVC) possessing the above properties may be used to derive the transforms for the L-shaped block. The property is that the small transform is included in the large one (twice the size) in some way. That is, one could obtain the small transform matrix from the large transform matrix.

FIG. 21A depicts a flowchart of a method for encoding an L-shaped block of image data according to an example.

In a step S2000, the L-shaped block of image data is transformed into an L-shaped block of coefficients by applying an orthogonal right transform and an orthogonal left transform. In a step S2010, the L-shaped block of coefficients is quantized with quantization weights to obtain an L-shaped block of quantized coefficients, wherein the quantization weights are associated with (e.g., mapped to) frequency indices of said coefficients. Said otherwise, a coefficient is quantized with a quantization weight associated with (e.g., corresponding to) the frequency index (or indices) of that coefficient.

In a step S2020, the L-shaped block of quantized coefficients is encoded.

FIGS. 21B and 21C both illustrate a transform (e.g, a forward transform) of prediction residuals (or of image data if prediction is not used) for a L-shaped block in the top-left configuration as applied in step S2000. The L-shaped blocks in other configurations (i.e, top right, bottom-left and bottom-right) can be mapped to (e.g., returned back to) the top-left configuration by rotating the L-shape block clockwise or anti-clockwise.

In a step S2100, the missing quadrant of the L-shaped block is filled (or padded) with zeros so as to obtain a square or rectangular block. For an L-shaped block in top-left configuration, the missing quadrant is the bottom right which is thus filled with zeros as illustrated on FIG. 21B. In a step S2102, a right transform (e.g, a right forward transform) corresponding to matrix T_{c} is applied on the obtained block, i.e, the filled block. This right transform is orthogonal. More precisely, the obtained block is right-multiplied with matrix T_{c} to obtain an intermediate block of coefficients IM1.

In a step S2104, the coefficients in the intermediate block of coefficients IM1 located in the missing quadrant (bottom-right quadrant in case of top-left configuration) of the L-shaped block are replaced by (or set to) zeros.

In an optional step S2106, the bottom-left quadrant (in case of top-left configuration) is scaled (namely multiplied) by 2 in case of a dyadic L-shape. In case of a non-dyadic L-shape, the scaling factor may be different, and depends on the particular transform and on the top width and the bottom width of the L-shape. In step S2106, the scaling by 2 may be implemented by a left bitshift. Scaling by 2 in step S2106 thus avoids multiplying by \sqrt{2} in inverse transform. The scaling step S2106 may be included into other scalings, e.g, scalings because of the use of integer transforms.

In a step S2108, a left transform (e.g, a left forward transform) corresponding to matrix Tt is applied on the block obtained at S2104 or after S2106, i.e, the scaled block. This left transform is orthogonal. More precisely, the obtained block is left-multiplied with matrix Tt to obtain a final block of coefficients.

In a step S2110, the coefficients in the final block of coefficients located in the missing quadrant (bottom-right quadrant in case of top-left configuration) of the L-shaped block are replaced by (or set to) zeros to obtain an L-shaped block of transform coefficients (hatched on FIG. 21B).

The L-shaped block of transform coefficients is finally binary encoded, i.e. coefficients are quantized, possibly binarized and entropy encoded, e.g. by CABAC.

In the example of FIG. 21A and FIG. 21B, the right transform applies first (S2102) and then the left transform applies (S2108). In another example, the left transform may apply first and then the right transform may apply.

### Quantization and Entropy Coding of an L-Shaped CU or L-Shaped Sub-Partition

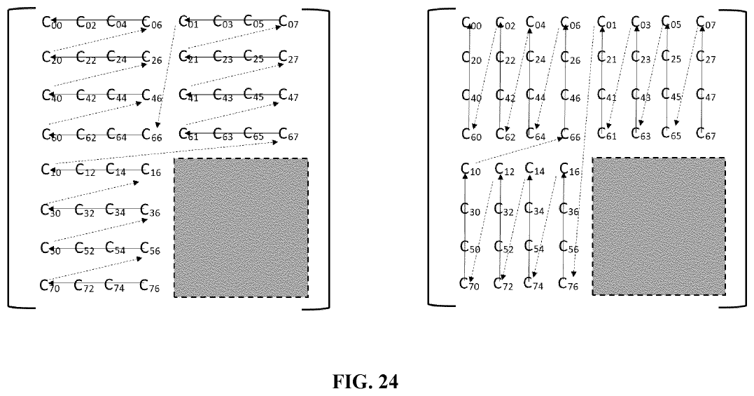

With the proposed transform method, the transform coefficients block of an L-shaped block has also the same L-shape since its bottom-right quadrant elements are all zeros and are thus not transmitted. After S2110, the transform coefficients of the L-shaped block are encoded. To this aim, they are first quantized by the encoder before being binary encoded. The quantizer used in normal transform coding can be used after associating (e.g. mapping) the quantization step sizes (or equivalently quantization weights) to the frequency indices of coefficients. As the new transform is obtained by concatenating the even and odd basis vectors, the frequency coefficient index has thus a different order from that obtained with a normal transform matrix as used in HEVC, VVC, etc. For example, for an 8×8 block, the coefficient indices are ordered as shown in FIG. 22. For any block with dyadic side lengths, square or rectangular, the coefficient index ordering can be analogously obtained. The coefficients in the block identify with dashed lines are all zeros and are thus not transmitted. The coefficient C_{i,j} is quantized with step size Q_{i,j}, where Q_{i,j} denotes the quantization step size used for the (i, j)th coefficient obtained with usual transforms. Therefore, the quantization weights used for quantizing the coefficients are associated with the frequency indices of the coefficients, said otherwise, a coefficient is quantized with quantization weight Q_{i,j} associated with (e.g., corresponding to) the frequency indices of that coefficient.

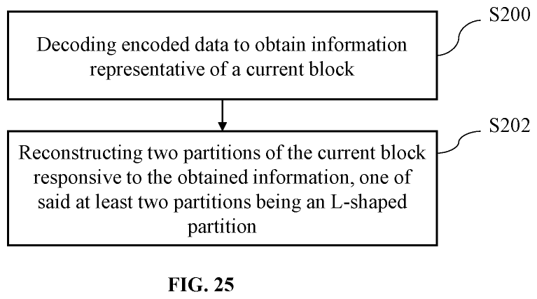

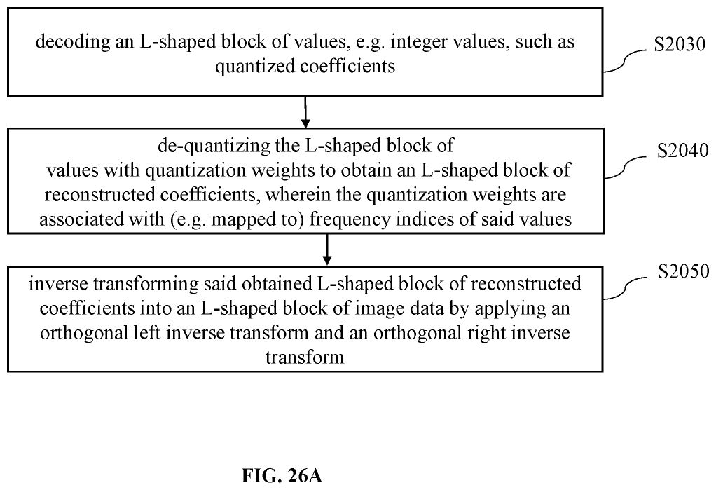

After the quantization, the coefficients are scanned for mapping them to a 1-dimensional array. The scanning can be performed normally with the exception that the coefficients in the bottom-right quadrant are left out. In video coding standards such as HEVC and VVC, the coefficients are scanned diagonally inside groups of 4×4 blocks called Coefficient Groups (CG) and the CGs themselves are scanned diagonally inside a transform unit (TU). The same rule can be applied here as well. For example, FIG. 23 shows a diagonal scanning pattern for a symmetric 8×8 L-shaped block. HEVC and VVC also specify horizontal and vertical scan patterns for specific intra prediction modes. Similar scan patterns can be applied for the transform coding of an L-shaped residual block, as shown in FIG. 24. The scanned quantized coefficients are encoded in binary form, i.e, possibly binarized, before being lossless entropy encoded, e.g. with CABAC The binary encoding of the coefficients based on significant map can be done as in VVC. ECM, etc., except that the significant map is computed only for the CGs in the three quadrants of the L-shaped block.

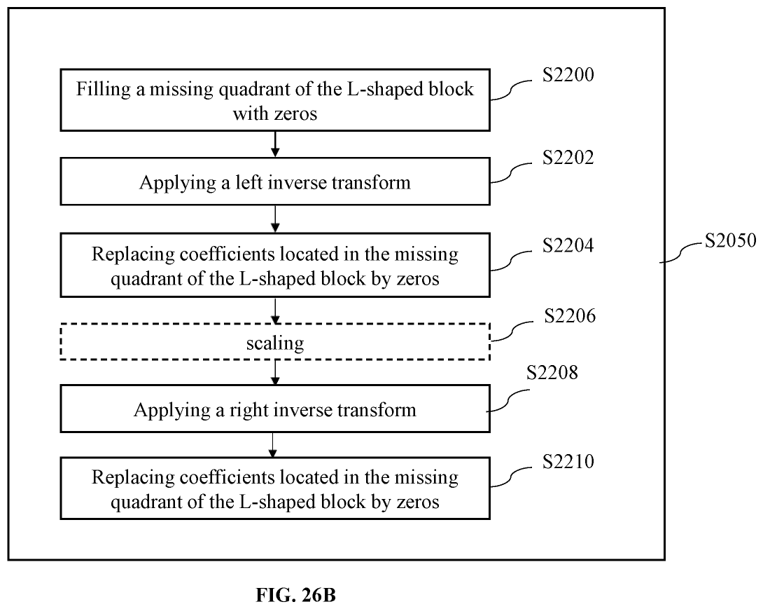

FIG. 25 depicts a flowchart of a decoding method according to an embodiment. The various embodiments/examples disclosed above with respect to the encoding method also apply to the decoding method.

In a step S200, encoded data are obtained. The obtained encoded data are entropy decoded (inverse binarization may also apply) to obtain information representative of a current block (also referred to as CU or parent CU) to be decoded. The information comprises for example quantized transform coefficients (called more simply “transform coefficients” in the following), prediction modes (e.g, intra prediction mode(s)), motion vectors in case of inter coding and possibly partitioning configuration information indicating how the current block is partitioned into at least two partitions.

In a step S202, the at least two partitions (also referred to child CUs or more simply CUs, ISP sub-partitions or more simply sub-partitions, blocks or sub-blocks) of the current block are reconstructed responsive to the obtained information, one of said at least two partitions being an L-shaped partition. The L-shaped partition can itself be a CU in the context of CTU recursive partitioning, or a sub-partition in the context of ISP.

In an example, the at least two partitions A and B are two child blocks resulting from CTU recursive partitioning of a parent block, A being an L-shaped CU that can be either intra or inter encoded and B being a square or rectangular CU or being a square or rectangular block that is recursively partitioned into CUs. Each partition has thus its own prediction mode. To decode the L-shaped CU A, prediction residuals are obtained by de-quantizing and inverse transforming the decoded transform coefficients of the L-shaped CU. By combining, e.g, adding, the prediction residuals and the predicted L-shaped CU, an image L-shaped CU is reconstructed. The predicted L-shaped CU results from either intra or inter prediction. The prediction on the decoder side is identical to the prediction on the encoder side. In case of intra prediction, an intra prediction mode is associated with the L-shape CU and may be a directional intra prediction mode (also referred to as angular prediction mode) or a non-directional prediction mode (also referred to as non-angular prediction mode), e.g. DC or Planar mode. The samples of the reconstructed L-shaped CU may be used as reference for further predictions, e.g, for an intra predicted CU B. The square or rectangular partition B may be directly decoded in a classical manner (i.e. by entropy coding, possibly inverse binarization, prediction, inverse quantization and inverse transform) in the case where it is a CU, i.e, in the case where it is not further recursively partitioned into a plurality of CUs. In the case where the square or rectangular partition B is recursively split into a plurality CUs, each of these CUs are decoded either as disclosed above in the case of an L-shape CU or in a classical manner in a case of a square or rectangular CU. The same principle applies to all L-shaped CUs in the CTU while the square or rectangular CUs are decoded in a classical manner. In other examples, partition B may be decoded before CU A in which case reconstructed samples partition CU B may be used as reference for decoding L-shaped CU A in the specific case where L-shaped CU A is intra coded.

In another example, the at least two partitions A and B are two ISP sub-partitions of an intra parent CU. In this case the L-shaped CU is intra decoded and the same prediction mode is used for both A and B, namely the intra prediction mode decoded for the parent CU. The prediction on the decoder side is identical to the prediction on the encoder side. To decode the L-shaped ISP sub-partition A (also called block A in the following), prediction residuals are obtained by de-quantizing and inverse transforming the decoded transform coefficients of the L-shaped sub-partition A. By combining, e.g, adding, the prediction residuals and the predicted L-shaped sub-partition, an image L-shaped sub-partition is reconstructed. The same intra prediction mode, namely the intra prediction mode decoded for the current block (i.e, parent CU), is used for both sub-partitions A and B. The intra prediction mode may be a directional intra prediction mode (also referred to as angular prediction mode) or a non-directional prediction mode (also referred to as non-angular prediction mode), e.g. DC or Planar mode. The samples of the reconstructed L-shaped sub-partition A may be used as reference for further predictions, e.g. for sub-partition B. The square or rectangular sub-partition B is decoded in a classical manner.

In other examples, sub-partition B may be decoded before sub-partition A in which case reconstructed samples from sub-partition B may be used as reference for decoding L-shaped sub-partition A.

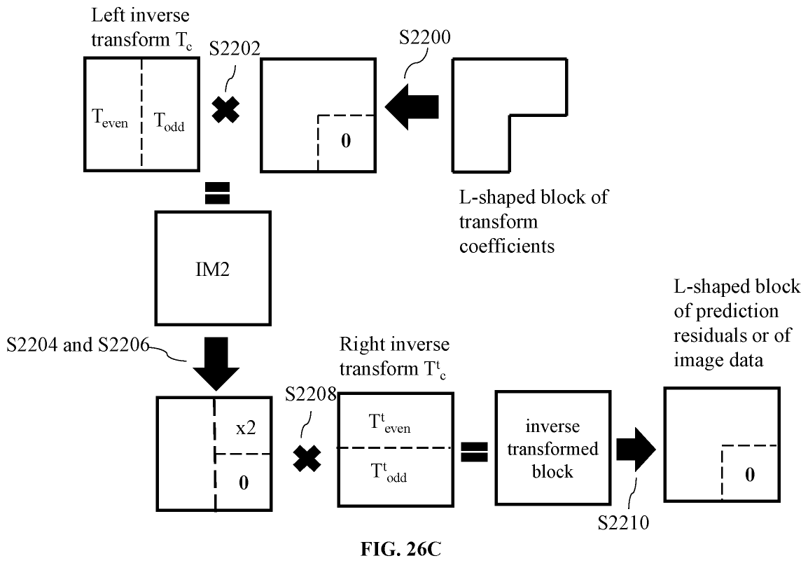

FIG. 26A depicts a flowchart of a method for decoding an L-shaped block of image data according to an example.

In a step S2030, an L-shaped block of values (e.g. values, for example integer values, corresponding to the quantized coefficients obtained on the encoder side at S2010) is decoded. In a step S2040, the L-shaped block of values is de-quantized with quantization weights to obtain an L-shaped block of reconstructed coefficients, wherein the quantization weights are associated with (e.g., mapped to) frequency indices of said values. Said otherwise, a value is de-quantized with a quantization weight associated with (e.g., corresponding to) the frequency index (or indices) of that value.

In a step S2050, the obtained L-shaped block of reconstructed coefficients is inverse transformed into an L-shaped block of image data by applying an orthogonal left inverse transform and an orthogonal right inverse transform.

FIGS. 26B and 26C both illustrate an inverse transform for a L-shaped block of reconstructed coefficients in the top-left configuration as applied in step S2050. The L-shaped blocks in other configurations (i.e, top right, bottom-left and bottom-right) can be mapped to (e.g., returned back to) the configuration top-left by rotating the L-shape block clockwise or anti-clockwise.

In a step S2200, the missing quadrant of the L-shaped block of reconstructed coefficients is filled (or padded) with zeros so as to obtain a square or rectangular block of reconstructed coefficients. For an L-shaped block in top-left configuration, the missing quadrant is the bottom right.

In a step S2202, a left inverse transform (corresponding to matrix T_{c}) is applied on the obtained block. More precisely, the obtained block is left-multiplied with matrix T_{c} to obtain an intermediate block of coefficients IM2.

In a step S2204, the coefficients in the intermediate block of coefficients IM2 located in the missing quadrant (bottom-right quadrant in case of top-left configuration) of the L-shaped block are replaced by (or set to) zeros.

In an optional step S2206, the top-right quadrant is scaled by 2. More generally, the elements in the columns containing the missing quadrant are multiplied by 2 in case of a dyadic L-shape. In case of a non-dyadic L-shape, the scaling factor may be different and depends on the top width and bottom width of the L-shape. In step S2206, the scaling by 2 may be implemented by a left bitshift. The scaling step S2206 may be included into other scalings, e.g, scalings because of the use of integer transforms. In a step S2208, a right inverse transform (corresponding to matrix

$${T}_{c}^{t} )$$

is applied on the block obtained at S2204 or S2206 if any. More precisely, the obtained block is right-multiplied with matrix

$${T}_{c}^{t}$$

to obtain an inverse transformed block of prediction residuals or of image data. In a step S2210, the coefficients in the final block of coefficients located in the missing quadrant (bottom-right quadrant in case of top-left configuration) of the L-shaped block, are replaced with (or set to) zeros to obtain an L-shaped block of prediction residuals or of image data.

An example of forward and inverse transforms of an 8×8 L-shaped block is given, i.e. M=N=8. In VVC or ECM, the forward transform is applied on prediction residuals. However, they may also be applied directly on image data. For illustration purpose of the above transform process, the input 8×8 L-shaped block is a block of image data. In the example below, the DCT transform specified in HEVC standard is used to derive the new transform T_{c} and

$${T}_{c}^{t} .$$

The DCT matrix specified in HEVC has integer elements; therefore after each transform operation there is a scaling that brings down the values within the working dynamic range. In the following “>>” indicates a right shift and “<<” indicates a left shift.

The DCT8 matrix in HEVC standard is

$$T = [ \begin{matrix}64 & 89 & 83 & 75 & 64 & 50 & 36 & 18 \\ 64 & 75 & 36 & ‐ 18 & ‐ 64 & ‐ 89 & ‐ 83 & ‐ 50 \\ 64 & 50 & ‐ 36 & ‐ 89 & ‐ 64 & 18 & 83 & 75 \\ 64 & 18 & ‐ 83 & ‐ 50 & 64 & 75 & ‐ 36 & ‐ 89 \\ 64 & ‐ 18 & ‐ 83 & 50 & 64 & ‐ 75 & ‐ 36 & 89 \\ 64 & ‐ 50 & ‐ 36 & 89 & ‐ 64 & ‐ 18 & 83 & ‐ 75 \\ 64 & ‐ 75 & 36 & 18 & ‐ 64 & 89 & ‐ 83 & 50 \\ 64 & ‐ 89 & 83 & ‐ 75 & 64 & ‐ 50 & 36 & ‐ 18\end{matrix} ]$$

Concatenating the even and odd columns, the transform matrix T_{c} is thus defined as follows:

$${T}_{c} = [ \begin{matrix}64 & 83 & 64 & 36 & 89 & 75 & 50 & 18 \\ 64 & 36 & - 64 & - 83 & 75 & - 18 & - 89 & - 50 \\ 64 & - 36 & - 64 & 83 & 50 & - 89 & 18 & 75 \\ 64 & - 83 & 64 & - 36 & 18 & - 50 & 75 & - 89 \\ 64 & - 83 & 64 & - 36 & - 18 & 50 & - 75 & 89 \\ 64 & - 36 & - 64 & 83 & - 50 & 89 & - 18 & - 75 \\ 64 & 36 & - 64 & - 83 & - 75 & 18 & 89 & 50 \\ 64 & 83 & 64 & 36 & - 89 & - 75 & - 50 & - 18\end{matrix} ]$$

The input L-shaped block after zero padding (i.e, after S2100) is defined as follows:

$$X = [ \begin{matrix}131 & 137 & 133 & 130 & 132 & 136 & 132 & 136 \\ 134 & 130 & 133 & 135 & 133 & 137 & 134 & 136 \\ 132 & 132 & 130 & 130 & 131 & 133 & 136 & 132 \\ 134 & 131 & 137 & 136 & 134 & 135 & 137 & 132 \\ 131 & 136 & 136 & 137 & 0 & 0 & 0 & 0 \\ 134 & 137 & 136 & 138 & 0 & 0 & 0 & 0 \\ 135 & 129 & 138 & 130 & 0 & 0 & 0 & 0 \\ 135 & 138 & 134 & 138 & 0 & 0 & 0 & 0\end{matrix} ]$$

After step S2102, (right forward transform (i.e., [ ]*T_{c}) and scaling (i.e., >>2, as scale factor=2⁻⁽⁸⁺³⁻⁹⁾=2⁻²)), the intermediate block IM1 is as follows:

$$[ \begin{matrix}17072 & 104 & - 144 & 45 & - 64 & - 25 & - 225 & - 97 \\ 17152 & - 13 & 64 & 143 & - 161 & 45 & 84 & - 79 \\ 16896 & 107 & - 96 & - 77 & - 117 & 97 & 57 & 16 \\ 17216 & - 119 & - 64 & 47 & - 34 & - 5 & 205 & 77 \\ 8640 & - 125 & - 64 & - 54 & 7781 & - 2894 & 1792 & - 1609 \\ 8720 & - 74 & - 16 & - 57 & 7871 & - 2855 & 1826 & - 1630 \\ 8512 & 23 & - 32 & 232 & 7733 & - 2745 & 1876 & - 1310 \\ 8720 & - 26 & 16 & - 110 & 7887 & - 2796 & 1808 & - 1676\end{matrix} ]$$

The above scaling by 2⁻² is because of the use of an integer DCT transform. The scale factor is 2−^{(B+M-9)}, where B is the bitdepth (which is 8 in this example) and M=log2(N) with N being the transform size. In the above example, N=8 and thus M=3.

After step S2104 and S2106, the following block is obtained:

$$[ \begin{matrix}17072 & 104 & - 144 & 45 & - 64 & - 25 & - 225 & - 97 \\ 17152 & - 13 & 64 & 143 & - 161 & 45 & 84 & - 79 \\ 16896 & 107 & - 96 & - 77 & - 117 & 97 & 57 & 16 \\ 17216 & - 119 & - 64 & 47 & - 34 & - 5 & 205 & 77 \\ 17280 & - 250 & - 128 & - 108 & 0 & 0 & 0 & 0 \\ 17440 & - 148 & - 32 & - 114 & 0 & 0 & 0 & 0 \\ 17024 & 46 & - 64 & 464 & 0 & 0 & 0 & 0 \\ 17440 & - 52 & 32 & - 220 & 0 & 0 & 0 & 0\end{matrix} ]$$

After step S2108 (Left forward transform

$$( i . e . {T}_{c}^{t} * [ ] )$$

and scaling (i.e., >>9, as scale factor=2⁻⁽³⁺⁶⁾=2⁻⁹)), the final block of transform coefficients is as follows:

$$[ \begin{matrix}17190 & - 41 & - 54 & 23 & - 47 & 14 & 15 & - 10 \\ - 9 & 73 & 22 & 38 & - 8 & - 7 & - 68 & - 35 \\ 62 & - 39 & - 22 & - 82 & 23 & - 22 & - 20 & 5 \\ 27 & 18 & - 15 & - 137 & 5 & 7 & - 35 & 3 \\ - 101 & 48 & - 16 & 8 & - 47 & 12 & - 14 & - 24 \\ 42 & - 32 & - 25 & 29 & 20 & - 22 & - 66 & - 22 \\ - 87 & 54 & - 32 & 106 & 13 & - 8 & - 5 & 16 \\ - 94 & 26 & - 39 & 19 & 2 & 10 & - 43 & - 7\end{matrix} ]$$

The above scaling by 2⁻⁹ is because of the use of an integer DCT transform. The scale factor is 2^{-(M+6)}.

After step S2110, the L-shaped block of transform coefficients is as follows:

$$[ \begin{matrix}17190 & - 41 & - 54 & 23 & - 47 & 14 & 15 & - 10 \\ - 9 & 73 & 22 & 38 & - 8 & - 7 & - 68 & - 35 \\ 62 & - 39 & - 22 & - 82 & 23 & - 22 & - 20 & 5 \\ 27 & 18 & - 15 & - 137 & 5 & 7 & - 35 & 3 \\ - 101 & 48 & - 16 & 8 & 0 & 0 & 0 & 0 \\ 42 & - 32 & - 25 & 29 & 0 & 0 & 0 & 0 \\ - 87 & 54 & - 32 & 106 & 0 & 0 & 0 & 0 \\ - 94 & 26 & - 39 & 19 & 0 & 0 & 0 & 0\end{matrix} ]$$

Assuming that the L-shaped block of transform coefficients is not quantized, the inverse transform process is as follows.

After step S2202 (Left inverse transform (i.e. T_{c}+[ ]) and scaling (i.e., >>7, as scale factor is 2⁻⁷)), the intermediate block IM2 is as follows:

$$[ \begin{matrix}8535 & 52 & - 72 & 23 & - 16 & - 7 & - 56 & - 24 \\ 8576 & - 7 & 32 & 72 & - 40 & 11 & 21 & - 19 \\ 8448 & 54 & - 48 & - 38 & - 30 & 25 & 14 & 4 \\ 8608 & - 60 & - 32 & 23 & - 8 & - 1 & 51 & 19 \\ 8640 & - 125 & - 64 & - 54 & - 8 & - 1 & 51 & 19 \\ 8720 & - 74 & - 16 & - 56 & - 30 & 25 & 14 & 4 \\ 8512 & 23 & - 32 & 233 & - 40 & 11 & 21 & - 19 \\ 8721 & - 27 & 16 & - 110 & - 16 & - 7 & - 56 & - 24\end{matrix} ]$$

After step S2204 and S2206, the obtained block is as follows:

$$[ \begin{matrix}8535 & 52 & - 72 & 23 & - 32 & - 14 & - 112 & - 48 \\ 8576 & - 7 & 32 & 72 & - 80 & 22 & 42 & - 38 \\ 8448 & 54 & - 48 & - 38 & - 60 & 50 & 28 & 8 \\ 8608 & - 60 & - 32 & 23 & - 16 & - 2 & 102 & 38 \\ 8640 & - 125 & - 64 & - 54 & 0 & 0 & 0 & 0 \\ 8720 & - 74 & - 16 & - 56 & 0 & 0 & 0 & 0 \\ 8512 & 23 & - 32 & 233 & 0 & 0 & 0 & 0 \\ 8721 & - 27 & 16 & - 110 & 0 & 0 & 0 & 0\end{matrix} ]$$

After S2208 (Right inverse transform

$$( i . e . [ ] * {T}_{c}^{t} )$$

as scale factor is 2⁻⁽²⁰⁻⁸⁾=2⁻¹²)), the inverse transformed block is as follows:

$$[ \begin{matrix}131 & 137 & 133 & 130 & 132 & 136 & 132 & 136 \\ 134 & 130 & 133 & 135 & 133 & 137 & 134 & 136 \\ 132 & 132 & 130 & 130 & 131 & 133 & 136 & 132 \\ 134 & 131 & 137 & 136 & 134 & 135 & 137 & 132 \\ 131 & 136 & 136 & 137 & 137 & 136 & 136 & 131 \\ 134 & 137 & 136 & 138 & 138 & 136 & 137 & 134 \\ 135 & 129 & 138 & 130 & 130 & 138 & 129 & 135 \\ 135 & 138 & 134 & 138 & 138 & 134 & 138 & 135\end{matrix} ]$$

The above scaling by 2⁻¹² is because of the use of an integer DCT transform. The scale factor is 2^{-(20-B)}.

After S2210, the L-shaped block of image data is as follows:

$$[ \begin{matrix}131 & 137 & 133 & 130 & 132 & 136 & 132 & 136 \\ 134 & 130 & 133 & 135 & 133 & 137 & 134 & 136 \\ 132 & 132 & 130 & 130 & 131 & 133 & 136 & 132 \\ 134 & 131 & 137 & 136 & 134 & 135 & 137 & 132 \\ 131 & 136 & 136 & 137 & 0 & 0 & 0 & 0 \\ 134 & 137 & 136 & 138 & 0 & 0 & 0 & 0 \\ 135 & 129 & 138 & 130 & 0 & 0 & 0 & 0 \\ 135 & 138 & 134 & 138 & 0 & 0 & 0 & 0\end{matrix} ]$$

This L-shaped block of image data after S2210 is identical to the input L-shaped block of image data.

For an asymmetric top-left L-shaped block having length M on the left and N on the top, the right transforms are obtained from DCT matrix of size N×N, and the left transforms are obtained from the DCT matrix of size M×M, after separating their even and odd columns in a likewise manner. The intermediate steps of scaling and zero-setting remain the same.

In the following, different examples of application scenarios are disclosed with their signaling.

CTU Recursive Partitioning with L-Shaped CUs

IN VVC and ECM, the Luma and Chroma components may share a same coding tree or Luma and Chroma may each have their own trees (known as dual tree). In the latter case, the Luma tree may be different from the Chroma tree.

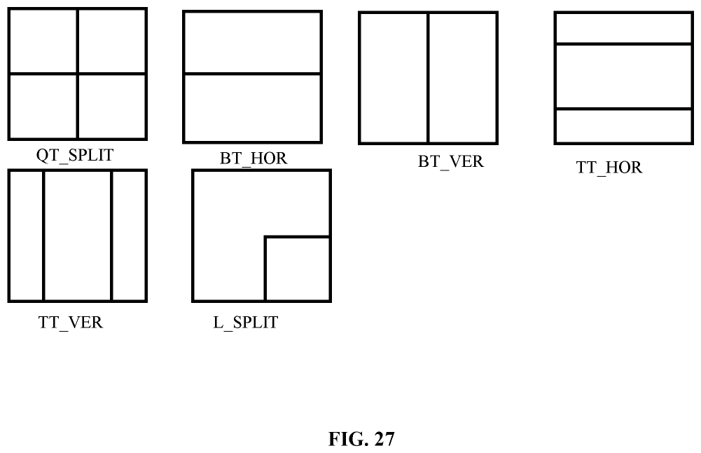

In an example, for the CU partitioning of a CTU (either a Luma CTU or a Chroma CTU or for both Luma and Chroma CTUs), L-shaped partitioning is added to the existing quadtree (QT), binary tree (BT) and triple tree (TT) partitionings as defined in VVC or ECM. That is, a CU is allowed to have an L-shape. In an example, in order to avoid redundancies, an L-shaped CU is not further split. However, a smaller square or rectangular CU resulting from an L-shaped CU partitioning can undergo further split including similar recursive L-shaped splits. In an example, to limit complexity, only the top-left split configuration is allowed. FIG. 27 depicts a set of all coding unit splitting modes according to an example. In the case where top-left L-shape partitioning is added to QT. BT and TT partitioning, an example of signaling could be as follows. A first bit is signaled to indicate whether a current block is split or not. If first bit is 1, i.e, the current block is indicated as being split, then a second bit is signaled to indicate if QT applies or not. If second bit is 0 (QT does not applies), then a next bit is signaled to indicate if L_SPLIT (i.e. L-shaped partitioning) applies or not. If not (i.e., L_SPLIT does not apply), then two bits are signaled next to indicate whether BT_VER, TT_VER, BT_HOR or TT_HOR applies. Another example could be as follows. A first bit is signaled to indicate whether a current block is split or not. If first bit is 1, i.e. current block is split, then a next bit b0 is signaled to indicate whether at least one of QT or L_SPLIT applies or none of them applies. If b0 is 1 (i.e., at least one of QT or L_SPLIT applies), then a next bit bl is signaled to indicate whether QT or L_SPLIT applies (e.g. bl is set to 1 to indicate QT and bl is set to 0 to indicate L_SPLIT, or vice versa). Else, i.e, if b0 is 0 (i.e. neither QT nor L_SPLIT applies), then two bits are signaled next to indicate whether BT_VER, TT_VER, BT_HOR or TT_HOR applies.

In another example, a plurality of split configurations are allowed (e.g. 2, 3 or 4) as depicted on FIG. 10 and FIG. 11. In the case where all four L-shaped partitions are added to QT, BT and TT partitions, an example of signaling could be as follows. A first bit is signaled to indicate whether a current block is split or not. If first bit is 1, i.e, the current block is indicated as being split, then a second bit is signaled to indicate if QT applies or not. If not (QT does not applies), then a next bit b0 is signaled to indicate if L-shaped partitioning applies or not. If b0 is 1 (i.e. L-shape partitioning applies), then two bits are signaled next to indicate which configuration between top-left, top-right, bottom left or bottom right applies. If b0 is 0 (i.e., L-shape partitioning does not apply), then two bits are signaled next to indicate whether BT_VER. TT_VER, BT_HOR or TT_HOR applies.

The transform is applied to the prediction residuals resulting from either intra or inter prediction. The transform coefficients in three quadrants are quantized with the quantization step sizes associated with (e.g., mapped to) their frequency indices. Subsequently, the quantized coefficients undergo a suitable scanning method before being binary encoded. In an example, in order to facilitate the scanning of coefficients based on coefficient groups of size 4×4, as done in HEVC, VVC, ECM, etc., the minimum size of the CU supporting L-shaped split is assumed to be 8×8.

The same principles may be applied to Chroma CU.

ISP Partitioning with L-Shaped Sub-Partitions

In an example, a L-shaped partitioning is added in intra prediction with sub-partitions (ISP) for Luma CUs. In VVC or in ECM, a CU with intra prediction can be split in two or four, vertical or horizontal, partitions where the partitions are sequentially processed for prediction, and encoding and decoding of the resulting prediction residual. L-shaped partition allows to split the CU into a sub-partition having L-shape and another having a square or rectangular shape. In an example, a plurality of split configurations are allowed (e.g. 2, 3 or 4) as depicted on FIG. 10 and FIG. 11. In another example, to limit the complexity, only one split is allowed: that is, the smaller square or rectangular partition is not further split. In an example, only one split configuration is allowed (top-left partition has an L-shape) besides the existing horizontal and vertical splits. The transform is applied to the prediction residuals in the L-shaped partition. The transform coefficients in three quadrants are quantized with the quantization step sizes associated with (e.g., mapped to) their frequency indices. Subsequently the quantized coefficients undergo a suitable scanning method before being binary encoded. In an example, in order to facilitate the scanning of coefficients based on coefficient groups of size 4×4, as done in HEVC, VVC, ECM, etc., the minimum size of the parent CU supporting ISP with L-shaped split is assumed to be 8×8. The pixels in the L-shaped partition are decoded after adding the predicted values to the prediction residuals, which are obtained after applying the inverse transform to the decoded prediction residual coefficients. The decoded pixels are then used as reference samples for the intra prediction in the smaller square or rectangular partition.

In the examples below; the signaling of the split type in ISP is detailed.

In a first example, the intra prediction with ISP, as in VVC or ECM, is extended with inclusion of the L-shaped partition. Only the top-left partition configuration is allowed. The encoder checks the RD performance with all split types possible including no split and signals the best split with a binary encoding scheme. The decoder decodes the split type. The signaling of the split type in ISP is changed. For example, the signaling can be done as ‘0’ for NO_SPLIT, ‘10’ for L_SPLIT, ‘110’ for HOR_SPLIT and ‘111’ for VER_SPLIT, where L_SPLIT denotes the L-shaped partitioning. Intra prediction for the L-shaped sub-partition is done using the reference samples of the parent CU. Then, the intra-prediction of the smaller sub-partition is done using the decoded samples in the L-shaped sub-partition on top and on left as reference samples. In an example, the minimum size of the smaller sub-partition is assumed to be 8 pixels. In a second example, the intra prediction with ISP, as in VVC or ECM, is extended with inclusion of L-shaped partitions. The number of allowed L-shaped configurations can be 1, 2. 3 or 4. When the number of configurations is 1, only the top-left configuration is allowed. When the number of configurations is 2, the top-left configuration together with any one of the other three type of configurations are allowed. When the number of configurations is 4, all four L-shaped configuration types are allowed. The encoder checks the RD performance with all split types possible including no split and signals the best split with a suitable binary encoding scheme. The decoder decodes the split type. The signaling of the split type in ISP is changed according to the number of added L-shaped configurations. For example, when only one L-shape split is allowed, the signaling can be done as ‘O’ for NO_SPLIT. ‘10’ for L_SPLIT. ‘110’ for HOR_SPLIT and ‘111’ for VER_SPLIT, where L_SPLIT denotes the L-shaped partitioning. Similarly, when all four L-shaped splits are allowed, the signaling can be done as for NO_SPLIT, ‘1000’ for L_SPLIT_TOP_LEFT, ‘1001’ for L_SPLIT_BOTTOM_RIGHT . . . ‘1010’ for L_SPLIT_TOP_RIGHT, ‘1011’ for L_SPLIT_BOTTOM_LEFT, ‘110’ for HOR_SPLIT and ‘111’ for VER_SPLIT, where L_SPLIT_X denotes the type of L-shaped split, etc. Intra prediction for the L-shaped sub-partition is done using the reference samples of the parent CU. Then the intra-prediction of the smaller sub-partition is done using the decoded samples in the L-shaped sub-partition and the reference samples of the parent CU, depending on the split type. In an example, the minimum size of the smaller sub-partition is assumed to be 8 pixels.

In a third example, the intra prediction with ISP, as in VVC or ECM, is modified to replace the existing horizontal and vertical splits by L-shaped splits. The number of allowed L-shaped configurations can be 1, 2, or 4. When the number of configurations is 1, only the top-left configuration is allowed. When the number of configurations is 2, the top-left configuration together with any one of the other three types of configurations are allowed. When the number of configurations is 4, all four L-shaped configuration types are allowed. The encoder checks the RD performance with all split types possible including no split and signals the best split with a suitable binary encoding scheme. The decoder decodes the split type. The signaling of the split type in ISP is changed according to the number of added L-shaped configurations. For example, when only one L-shape split is allowed, the signaling can be done as ‘0’ for NO_SPLIT and ‘1’ for L_SPLIT, where L_SPLIT denotes the L-shaped split. Similarly, when all four L-shaped splits are allowed, the signaling can be done as ‘0’ for NO_SPLIT, ‘100’ for L_SPLIT_TOP_LEFT ‘101’ for L_SPLIT_BOTTOM_RIGHT, ‘110’ for L_SPLIT_TOP_RIGHT, ‘111’ for L_SPLIT_BOTTOM_LEFT, where L_SPLIT_X denotes the type of L-shaped split, etc. Intra prediction for the L-shaped sub-partition is done using the reference samples of the parent CU. Then the intra-prediction of the smaller sub-partition is done using the decoded samples in the L-shaped sub-partition, and the reference samples of the parent CU, depending on the split type. The minimum size of the smaller sub-partition is assumed to be 8 pixels.

In a fourth example, the intra prediction with ISP, as in VVC or ECM, is extended with inclusion of L-shaped partitions. The number of allowed L-shaped partitions is two. The first partition has one L-shaped sub-partition and one square or rectangular sub-partition. The second partition has two L-shaped sub-partitions and one square or rectangular sub-partition. The second L-shaped sub-partition is obtained by splitting the square or rectangular sub-partition once again. Both L-shaped sub-partitions can have only the top-left configuration. These two new partitions can replace the existing horizontal and vertical splits in ISP, or they can be included in addition to them.

The signaling scheme is decided accordingly. When there are two L-shaped sub-partitions, intra prediction for the first sub-partition is done using the reference samples of the parent CU.

Then the intra-prediction of the second sub-partition is done using the decoded samples in the first L-shaped sub-partition on the left and the top as reference samples. Then, finally, the intra prediction in the smaller sub-partition is done using the decoded samples in the second L-shaped sub-partition on the left and the top as reference samples.

The present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS (Sequence Parameter Set), a PPS (Picture Parameter Set), a NAL unit (Network Abstraction Layer), a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of re-sampling filter coefficients. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

In an example, a method of encoding an L-shaped block of image data is disclosed that comprises:
transforming said L-shaped block of image data into an L-shaped block of coefficients by applying an orthogonal right transform and an orthogonal left transform;
quantizing the L-shaped block of coefficients with quantization weights to obtain an L-shaped block of quantized coefficients, wherein the quantization weights are associated with (e.g., mapped to) frequency indices of said coefficients; and encoding the L-shaped block of quantized coefficients into encoded data.

In an example, transforming said L-shaped block of image data into an L-shaped block of coefficients comprises:
filling a missing quadrant of the L-shaped block with zeros to obtain a first filled block;
applying said orthogonal right transform on said first filled block to obtain a first block of coefficients;
replacing coefficients of said first block located in the missing quadrant of the L-shaped block by zeros to obtain a second filled block;
applying said orthogonal left transform on said second filled block to obtain a second block of coefficients;
replacing coefficients of said second block located in the missing quadrant of the L-shaped block by zeros to obtain an L-shaped block of coefficients.

In an example, wherein said image data are prediction residuals.

In an example, applying said orthogonal right transform on said first filled block comprises multiplying said first filled block by a transform matrix concatenating even and odd columns of a Discrete Cosine Transform.

In an example, applying said orthogonal left transform on said second filled block comprises multiplying said second filled block by a transpose of said transform matrix concatenating even and odd columns of a Discrete Cosine Transform.

In an example, a method of decoding an L-shaped block of image data is disclosed that comprises:
decoding encoded data to an L-shaped block of values (e.g, integer values);
de-quantizing the L-shaped block of values with quantization weights to obtain an L-shaped block of reconstructed coefficients, wherein the quantization weights are associated with (e.g., mapped to) frequency indices of said values; and
inverse transforming said obtained L-shaped block of reconstructed coefficients into an L-shaped block of image data by applying an orthogonal left inverse transform and an orthogonal right inverse transform.

In an example, inverse transforming said obtained L-shaped block of reconstructed coefficients comprises:
filling a missing quadrant of said L-shaped block of reconstructed coefficients with zeros to obtain a first filled block;
applying an orthogonal left inverse transform on said first filled block to obtain a first block of coefficients;
replacing coefficients of said first block located in the missing quadrant of the L-shaped block by zeros to obtain a second filled block;
applying an orthogonal right inverse transform on said second filled block to obtain a second block of coefficients; and
replacing coefficients of said second block located in the missing quadrant of the L-shaped block by zeros to obtain an L-shaped block of image data.

In an example, said image data are prediction residuals.

In an example, applying an orthogonal left inverse transform on said first filled block comprises multiplying said first filled block by a transform matrix concatenating even and odd columns of a Discrete Cosine Transform.

In an example, applying an orthogonal right inverse transform on said second filled block comprises multiplying said second filled block by a transpose of said transform matrix concatenating even and odd columns of a Discrete Cosine Transform.

1. A method of encoding an L-shaped block of image data comprising:
transforming the L-shaped block of image data into an L-shaped block of coefficients;
quantizing the L-shaped block of coefficients with quantization weights to obtain an L-shaped block of quantized coefficients; and
encoding the L-shaped block of quantized coefficients into encoded data,
wherein transforming the L-shaped block of image data into an L-shaped block of coefficients comprises:
filling a missing quadrant of the L-shaped block with zeros to obtain a first filled block;
applying an orthogonal right transform on the first filled block to obtain a first block of coefficients;
replacing coefficients of the first block located in the missing quadrant of the L-shaped block by zeros to obtain a second filled block;
applying an orthogonal left transform on the second filled block to obtain a second block of coefficients; and
replacing coefficients of the second block located in the missing quadrant of the L-shaped block by zeros to obtain an L-shaped block of coefficients.

2. (canceled)

3. The method of claim 1, wherein the image data are prediction residuals.

4. The method of claim 2, wherein applying the orthogonal right transform on the first filled block comprises multiplying the first filled block by a transform matrix concatenating even and odd columns of a Discrete Cosine Transform.

5. The method of claim 41, wherein applying the orthogonal left transform on the second filled block comprises multiplying the second filled block by a transpose of a transform matrix concatenating even and odd columns of a Discrete Cosine Transform.

6. A method of decoding an L-shaped block of image data comprising:
decoding encoded data to an L-shaped block of values;
de-quantizing the L-shaped block of values with quantization weights to obtain an L-shaped block of reconstructed coefficients;
wherein inverse transforming the obtained L-shaped block of reconstructed coefficients comprises:
filling a missing quadrant of the L-shaped block of reconstructed coefficients with zeros to obtain a first filled block;
applying an orthogonal left inverse transform on the first filled block to obtain a first block of coefficients;
replacing coefficients of the first block located in the missing quadrant of the L-shaped block by zeros to obtain a second filled block;
applying an orthogonal right inverse transform on the second filled block to obtain a second block of coefficients; and
replacing coefficients of the second block located in the missing quadrant of the L-shaped block by zeros to obtain an L-shaped block of image data.

7. (canceled)

8. The method of claim 6, wherein the image data are prediction residuals.

9. The method of claim 6, wherein applying an orthogonal left inverse transform on the first filled block comprises multiplying the first filled block by a transform matrix concatenating even and odd columns of a Discrete Cosine Transform.

10. The method of claim 6, wherein applying an orthogonal right inverse transform on the second filled block comprises multiplying the second filled block by a transpose of a transform matrix concatenating even and odd columns of a Discrete Cosine Transform.

11. An encoding apparatus comprising one or more processors and at least one memory coupled to the one or more processors, wherein the one or more processors are configured to perform:
transforming an L-shaped block of image data into an L-shaped block of coefficients;
quantizing the L-shaped block of coefficients with quantization weights to obtain an L-shaped block of quantized coefficients; and
encoding the L-shaped block of quantized coefficients into encoded data,
wherein transforming the L-shaped block of image data into an L-shaped block of coefficients comprises:
filling a missing quadrant of the L-shaped block with zeros to obtain a first filled block;
applying an orthogonal right transform on the first filled block to obtain a first block of coefficients;
replacing coefficients of the first block located in the missing quadrant of the L-shaped block by zeros to obtain a second filled block;
applying an orthogonal left transform on the second filled block to obtain a second block of coefficients; and
replacing coefficients of the second block located in the missing quadrant of the L-shaped block by zeros to obtain an L-shaped block of coefficients.

12. A decoding apparatus comprising one or more processors and at least one memory coupled to the one or more processors, wherein the one or more processors are configured to perform:
decoding encoded data to an L-shaped block of values;
de-quantizing the L-shaped block of values with quantization weights to obtain an L-shaped block of reconstructed coefficients;
filling a missing quadrant of the L-shaped block of reconstructed coefficients with zeros to obtain a first filled block;
applying an orthogonal left inverse transform on the first filled block to obtain a first block of coefficients;
replacing coefficients of the first block located in the missing quadrant of the L-shaped block by zeros to obtain a second filled block;
applying an orthogonal right inverse transform on the second filled block to obtain a second block of coefficients; and
replacing coefficients of the second block located in the missing quadrant of the L-shaped block by zeros to obtain an L-shaped block of image data.

13-14. (canceled)

15. The encoding apparatus of claim 11, wherein the image data are prediction residuals.

16. The encoding apparatus of claim 11, wherein applying the orthogonal right transform on the first filled block comprises multiplying the first filled block by a transform matrix concatenating even and odd columns of a Discrete Cosine Transform.

17. The encoding apparatus of claim 11, wherein applying the orthogonal left transform on the second filled block comprises multiplying the second filled block by a transpose of a transform matrix concatenating even and odd columns of a Discrete Cosine Transform.

18. The decoding apparatus of claim 12, wherein the image data are prediction residuals.

19. The decoding apparatus of claim 12, wherein applying an orthogonal left inverse transform on the first filled block comprises multiplying the first filled block by a transform matrix concatenating even and odd columns of a Discrete Cosine Transform.

20. The decoding apparatus of claim 12, wherein applying an orthogonal right inverse transform on the second filled block comprises multiplying the second filled block by a transpose of a transform matrix concatenating even and odd columns of a Discrete Cosine Transform.
